(19) United States
(12) Patent Application Publication
(10) Pub. No.: US 2005/0035033 A1
(43) Pub. Date: Feb. 17, 2005

(54) Methods for sealing screen assemblies on vibratory separators

(76) Inventors: Thomas C. Adams, Hockley, TX (US); Haynes B. Smith, Kingwood, TX (US); James Adams, Couroe, TX (US); Charles N. Grichar, Houston, TX (US); Kerry T. Ward, Cypress, TX (US); George Alexander Burnett, Aberdeen (GB); Kenneth W. Seyffert, Houston, TX (US); David L. Schulte JR., Broussard, LA (US); Guy L. McClung III, Spring, TX (US)

Correspondence Address: Guy McClung, 16690 Champion Forest Drive, Spring, TX, 77379-7023, US

(21) Appl. No.: 10/762,768

(22) Filed: Jan. 22, 2004

Related U.S. Application Data
(63) Continuation-in-part of application No. 10/050,690, filed on Jan. 16, 2002.
(63) Continuation-in-part of application No. 10/057,755, filed on Jan. 23, 2002, now Pat. No. 6,769,550.
(63) Continuation-in-part of application No. 10/050,690, filed on Jan. 16, 2002.
Application No. 10/050,690 is a continuation-in-part of application No. 10/037,474, filed on Oct. 19, 2001, now Pat. No. 6,669,985.
Application No. 10/037,474 is a continuation-in-part of application No. 09/603,531, filed on Jun. 27, 2000, now Pat. No. 6,450,345.
Application No. 09/603,531 is a continuation-in-part of application No. 09/517,212, filed on Mar. 2, 2000, now Pat. No. 6,565,698.
Application No. 09/517,212 is a continuation-in-part of application No. 09/454,722, filed on Dec. 4, 1999, now abandoned.
Application No. 09/454,722 is a continuation-in-part of application No. 09/390,231, filed on Sep. 3, 1999, now Pat. No. 6,325,216.
Application No. 09/390,231 is a continuation-in-part of application No. 09/276,267, filed on Mar. 25, 1999, now Pat. No. 6,032,806.

(51) Int. Cl. B07B 1/49

(52) U.S. Cl. 209/392

(57) ABSTRACT

A method for mounting a screen assembly to a screen mounting structure of a vibratory separator to effectively seal the screen assembly in place, the method in certain aspects including locating the screen assembly on a screen mounting structure of the separator, positioning the screen assembly so that crossmembers of a four-sided generally rectangular support of the screen assembly are either all parallel to or are all transverse to a direction of material flowing across the screen assembly, forcing two sides of the support of the screen assembly down with a crowning apparatus to effect crowning of the screen assembly, the support sufficiently flexible so that two sides thereof other than the two forced-down sides sealingly contact a surface of the screen mounting structure along substantially all of their length.

### RELATED APPLICATIONS

This is a continuation-in-part of pending U.S. patent application Ser. No. 10/050,690 filed on Jan. 16, 2002; Ser. No. 10/053,350 filed on Jan. 16, 2002 (now U.S. Pat. No. 6,662,952 B2 issued Dec. 16, 2003); and Ser. No. 10/057,755 filed Jan. 23, 2002; and U.S. application Ser. No. 10/050,690 is a continuation-in-part of U.S. application Ser. No. 10/037,474 filed Oct. 19, 2001 (now U.S. Pat. No. 6,669,985 issued Dec. 30, 2003), which is a continuation-in-part of U.S. application Ser. No. 09/603,531 filed Jun. 27, 2000 (now U.S. Pat. No. 6,450,345 issued Sep. 17, 2002) which is a continuation-in-part of U.S. application Ser. No. 09/517,212 filed Mar. 2, 2000 (now U.S. Pat. No. 6,565,698 issued May 20, 2003) which is a continuation-in-part of U.S. application Ser. No. 09/454,722 filed on Dec. 4, 1999 which is a continuation-in-part of U.S. application Ser. No. 09/390,231 filed Sep. 3, 1999 (now U.S. Pat. No. 6,325,216 issued Dec. 4, 2001) which is a continuation-in-part of U.S. Pat. No. 6,032,806 issued Mar. 25, 1999; and this application is a continuation-in-part of U.S. application Ser. No. 09/707,277 filed Nov. 6, 2000 (now U.S. Pat. No. 6,581,781 issued Jun. 24, 2003) which is a continuation-in-part of U.S. application Ser. No. 09/183,004 filed Oct. 30, 1998 issued as U.S. Pat. No. 6,186,337 on Feb. 13, 2001—all of which applications and patents are incorporated herein in their entirety for all purposes and with respect to all of which the present invention claims priority under the Patent Laws.

### BACKGROUND OF THE INVENTION

1. Field of the Invention

The present invention is directed to screen assemblies for shale shakers, mounting structure for such screen assemblies, shale shakers with such screen assemblies, and methods of using such mounting structures, screen assemblies and shakers.

2. Description of Related Art

Vibratory separators are used in a wide variety of industries to separate materials such as liquids from solids or solids from solids. Typically such separators have a basket or other screen holding or mounting apparatus mounted in or over a receiving receptacle or tank and vibrating apparatus for vibrating the basket. One or more screens is mounted in the basket. Material to be treated is introduced to the screen(s) either by flowing it directly onto the screen(s) or by flowing it into a container, tank, or “possum belly” from which it then flows to the screen(s). Also in some multi-screen apparatuses material flows from an upper screen onto a lower screen.

The prior art discloses a variety of mounting systems and apparatuses for releasably mounting a screen assembly to a shale shaker. These include drawbar and hookstrip apparatuses; inflatable device systems; wedge systems; e.g. the systems described in U.S. Pat. No. 6,179,128 issued Jan. 30, 2001; U.S. Pat. No. 5,392,925 issued Feb. 28, 1995; U.S. Pat. No. 4,882,054 issued Nov. 21, 1989; U.S. Pat. No. 4,582,597 issued Apr. 15, 1986; and in the prior art referred to in each of these references.

Referring now to FIG. 5, a prior art shale shaker 1 has a screen 2 (with screen or screening cloth or mesh as desired) mounted on vibratable screen mounting apparatus or “basket” 3. The screen 2 may be any known screen or screens. The basket 3 is mounted on springs 4 (only two shown; two as shown are on the opposite side) which are supported from a frame 6. The basket 3 is vibrated by a motor 5 and interconnected vibrating apparatus 8 which is mounted on the basket 3 for vibrating the basket and the screens. Elevator apparatus 7 provides for raising and lowering of the basket end.

FIG. 6 discloses an example of a prior art shaker system (e.g. as shown in U.S. Pat. No. 5,190,645 incorporated fully herein for all purposes). The system A has a shale shaker K having a screen or screens S. The screen(s) S are mounted in a typical shaker basket B and one or more vibrators V (any known suitable shaker vibrator) vibrate the basket B and hence the screen(s) S. The other components of the system A are as described in U.S. Pat. No. 5,190,645.

There is a need, recognized by the present inventors, for efficient and effective screen mounting methods, particularly for mounting relatively rigid screen assemblies with an effective seal between them and screen mounting structure.

### SUMMARY OF THE PRESENT INVENTION

The present invention, in certain aspects, discloses methods for mounting a screen assembly to a screen mounting structure of a vibratory separator to facilitate sealing of an interface between the the screen assembly and the screen mounting structure, the method including locating the screen assembly on the screen mounting structure so that all crossmembers of a support supporting screening material of the screen assembly are all either generally transverse to or all generally parallel to the a direction of material flow from one side of the screen assembly to the other, and forcing first and second sides of the support down with crowning apparatus to effect crowning of the screen assembly, third and fourth sides which are at right angles to the first and second sides rigid yet sufficiently flexible so that with the screen assembly in a crowned configuration the third side and the fourth side each along substantially all of the length thereof sealingly contact a surface of the screen mounting structure.

A shale shaker, in one embodiment according to the present invention (e.g. with basic components as the prior art shakers described or referred to herein) is, according to the present invention, provided with one or more screen assemblies with such projecting members as described herein according to the present invention. Such a shaker has a hole or holes in its screen-mounting tray, bed or deck corresponding to the pin(s) and/or finger(s) of the screen assembly (or assemblies) mounted thereon.

A screen assembly according to the present invention may be any known shale shaker screen or screen assembly to which the pin(s), stud(s), and/or finger(s) are added.

The present invention, in one embodiment includes a shale shaker with a frame; a “basket” or screen mounting apparatus in the frame with a bed, tray or deck for a screen assembly or screen assemblies therein; pin(s) and/or finger(s) projecting up from the bed, tray or deck; one or more screen assemblies according to the present invention with a hole (or holes) corresponding to the pin(s) and/or finger(s) of the deck, bed or tray; the one or more screen assemblies mounted to the basket with the pin(s) and/or finger(s) projecting into the corresponding hole or holes of the screen assembly or screen assemblies according to the present invention; basket vibrating apparatus; and a collection tank or receptacle below the basket. In one particular aspect such a shale shaker treats drilling fluid with drilled cuttings, debris, etc. entrained therein. With such a shale shaker, the pin(s) and/or finger(s) of the deck, bed or tray can be formed integrally of the deck, bed or tray; or the pin(s) and/or finger(s) may be part of strips, bars, wear strips or elongated members that are releasably connectable to the deck, bed or tray. In one particular aspect, such pin(s) and/or finger(s) are on separate wear strips that are releasably connected to a shaker tray and which, in position thereon, provide an upward force that forces a screen assembly thereabove upwardly, facilitating the maintenance in position of the screen assembly. Wear strips that are made in an originally upwardly bowed configuration can provide such an upward force or an initially flat wear strip that is installed so that it bows slightly upwardly can provide such a force.

In other aspects of the present invention a hole or holes is or are provided in the upper surface of a support of a screen assembly (or in the lower surface of the support), e.g., but not limited to in part of a tubular frame of a screen assembly and a projecting member or members are moved into such hole or holes (e.g., a downwardly projecting member on a screen assembly holding member or structure or on an air bladder that is inflated above a screen assembly to secure it in place on a shaker deck, bed or tray or an upwardly projecting member on a screen assembly holding member or structure or on an air bladder that is inflated below a screen assembly to secure it in place on a shaker deck, bed or tray). In certain such aspects the screen assemblies shown in the drawings and described in detail below have the hole or holes in the topmost surface of a screen frame or tubular support rather than in the bottom thereof.

It is, therefore, an object of at least certain preferred embodiments of the present invention to provide:
New, useful, unique, efficient, non-obvious screen supports, screen assemblies with such screen supports, vibratory separators and shale shakers for using such screen assemblies, and methods of use of these things; and, in particular aspects, such screen assemblies with a support that is sufficiently non-rigid and/or flexible so that sides thereof not parallel to the general direction of the flow of material over the top of the screen assembly are effectively sealed against screen mounting structure;
New, useful, unique, efficient, non-obvious screen assemblies for shale shakers and methods for using them to separate components of material to be treated thereby;
Such screen assemblies, and shale shakers therewith, with one or more downwardly projecting members (e.g., studs, positioning pins or fingers) for releasably positioning and mounting such a screen assembly on a shale shaker mounting structure (bed, tray deck); and
New, useful, unique, efficient, non-obvious shale shakers with one or more upwardly projecting members on the shaker's deck, bed or tray for insertion into corresponding hole(s) on a screen assembly support of a screen assembly to be mounted on the shaker.
New, useful, unique, efficient, non-obvious screen assemblies with a plurality of glued-together layers (e.g., one two, three or more) of screening material with at least one hole through the layers and through a plate on one side of the combination of layers of screening material, and, in one aspect, such a plate on both sides of the combination of glued-together layers of screening material; and in one aspect such a combination of glued-together layers of screening material with a hook apparatus on one side or end thereof for selective tensioning in a shale shaker; and in one aspect such a screen assembly with one or more projecting members projecting from a plate on the top of or from a plate on the bottom of the screen assembly;
New, useful, unique, efficient, non-obvious wear strips for screen assembly mounting structures of shale shakers and methods for using them.

The present invention recognizes and addresses the previously-mentioned problems and long-felt needs and provides a solution to those problems and a satisfactory meeting of those needs in its various possible embodiments and equivalents thereof. To one of skill in this art who has the benefits of this invention's realizations, teachings, disclosures, and suggestions, other purposes and advantages will be appreciated from the following description of preferred embodiments, given for the purpose of disclosure, when taken in conjunction with the accompanying drawings. The detail in these descriptions is not intended to thwart this patent's object to claim this invention no matter how others may later disguise it by variations in form or additions of further improvements.

### DESCRIPTION OF THE DRAWINGS

A more particular description of embodiments of the invention briefly summarized above may be had by references to the embodiments which are shown in the drawings which form a part of this specification. These drawings illustrate certain preferred embodiments and are not to be used to improperly limit the scope of the invention which may have other equally effective or equivalent embodiments.

FIG. 1A is a top view of a screen assembly according to the present invention with a screen support according to the present invention. FIG. 1B is a side view of the screen assembly of FIG. 1A.

FIGS. 2A and 3A are side views in cross-section of fasteners system for use in releasably connecting a screen assembly according to the present invention to a shale shaker. FIG. 2B shows the fastener of FIG. 2A in position connecting a screen assembly to a shale shaker. FIG. 3B shows the fastener of FIG. 3A in position following activation connecting a screen assembly to a shale shaker.

FIG. 4 is a side view in cross-section of a fastener system releasably connecting a screen assembly according to the present invention to a shale shaker.

FIG. 5 is a perspective view of and FIG. 6 is a schematic view of a prior art shale shaker.

FIGS. 7-9 are perspective views of shale shakers according to the present invention.

FIG. 10A is a schematic view of a system according to the present invention. FIG. 10B shows a shale shaker of the system of FIG. 10A.

FIGS. 11, 12, 13 and 15 are top views of screen assemblies according to the present invention.

FIG. 14A is a top view of a plastic grid according to the present invention.

FIG. 14B is a perspective view of a plastic grid according to the present invention.

FIG. 16 is a cross-sectional view of a screen assembly according to the present invention.

FIG. 17 is a perspective view of a frame support for a screen assembly according to the present invention.

FIG. 18A is a top view of a screen assembly according to the present invention. FIG. 18B is a bottom view of the screen assembly of FIG. 18A. FIG. 18C is an end view of one end of the screen assembly of FIG. 18A (and the opposing end is identical to that of FIG. 18C). FIG. 18D is a side view of one side of the screen assembly of FIG. 18A (and the opposing side is identical to that of FIG. 18C). FIG. 18 is a partial bottom perspective view of the screen assembly of 18A. FIG. 18F is a partial bottom view of the screen assembly of FIG. 18A.

FIG. 19 is a perspective view of a screen assembly mounting structure for a shale shaker according to the present invention.

FIG. 20A is a top view of a screen assembly according to the present invention. FIG. 20B is an end view, FIG. 20C is a side view and FIG. 20D is a bottom view of the screen assembly of FIG. 20A. FIG. 20E is a top view of possible hole shapes according to the present invention for the screen assembly of FIG. 20A.

FIG. 21 is a perspective view of a screen assembly mounting structure for a shale shaker according to the present invention.

FIG. 22 is a perspective view of a screen assembly mounting structure for a shale shaker according to the present invention.

FIG. 23A is a top view of a screen assembly according to the present invention. FIG. 23B is an end view, FIG. 23C is a side view and FIG. 23D is a bottom view of the screen assembly of FIG. 23A.

FIG. 24 is a perspective view of a screen assembly mounting structure for a shale shaker according to the present invention.

FIGS. 25A-F and 25H are side schematic views of shale shakers according to the present invention. FIG. 25G is a side view of a screen assembly for the shale shaker of FIG. 25H.

FIG. 26 is a perspective view of a shale shaker according to the present invention.

FIG. 27 is a perspective view of a shale shaker according to the present invention.

FIG. 28 is a top view of a wear strip according to the present invention.

FIG. 29A is a top view of a wear strip according to the present invention. FIG. 29B is a side view of the wear strip of FIG. 29A.

FIG. 30A is a top view of a wear strip according to the present invention. FIG. 30B is a side view of the wear strip of FIG. 30A.

FIG. 31A is a top view of a wear strip according to the present invention. FIG. 31B is a side view of the wear strip of FIG. 31A.

FIG. 32A is a top view of a wear strip according to the present invention. FIG. 32B is a side view of the wear strip of FIG. 32A. FIG. 32C is a side view of an alternative embodiment of the wear strip of FIG. 32A. FIGS. 32D and 32E are top views of wear strips according to the present invention.

FIG. 33 is a perspective view of a screen assembly mounting structure for a shale shaker according to the present invention.

FIG. 34A is a top view of a wear strip according to the present invention. FIG. 34B is a side view of the wear strip of FIG. 34A.

FIG. 35A is a top view of a wear strip according to the present invention. FIG. 35B is a side view of the wear strip of FIG. 35A.

FIG. 36A is a top view of a wear strip according to the present invention. FIG. 36B is a side view of the wear strip of FIG. 36A.

FIG. 37A is a top view of a wear strip according to the present invention. FIG. 37B is a side view of the wear strip of FIG. 37A.

FIG. 38A is a top view of a wear strip according to the present invention. FIG. 38B is a side view of the wear strip of FIG. 38A.

FIG. 39A is a top view of a wear strip according to the present invention. FIG. 39B is a side view of the wear strip of FIG. 39A.

FIG. 40A is a top view of a wear strip according to the present invention. FIG. 40B is a side view of the wear strip of FIG. 40A.

FIG. 41A is a top view of a wear strip according to the present invention. FIG. 41B is a side view of the wear strip of FIG. 41A.

FIG. 42 is a perspective view of a screen assembly mounting structure for a shale shaker according to the present invention.

FIG. 43 is a perspective view of a screen assembly mounting structure for a shale shaker according to the present invention.

FIG. 44 is a bottom view of a wear strip of FIG. 43.

FIG. 45 is a perspective view of a screen assembly mounting structure for a shale shaker according to the present invention.

FIG. 46 is a perspective view of a screen assembly mounting structure for a shale shaker according to the present invention.

FIG. 47 is a perspective view of a screen assembly mounting structure for a shale shaker according to the present invention.

FIG. 48 is a bottom view of a screen assembly according to the present invention.

FIG. 49A is a perspective view of the upstanding member for embodiments of the present invention. FIG. 49B is a perspective view of the hole for embodiments of the present invention.

FIGS. 50A, 50C, and 50E are top views of screen assemblies according to the present invention. FIG. 50B is a side cross-section view of the screen assembly of FIG. 50A. FIG. 50D is a side cross-section view of the screen assembly of FIG. 50C. FIG. 50F is a side cross-section view of the screen assembly of FIG. 50E.

FIG. 50G is a top view of a screen assembly according to the present invention.

FIG. 51 is a side view of a wear strip according to the present invention.

FIG. 52 is a top view of a prior art support for a screen assembly.

FIG. 53A is a perspective view of a screen assembly support according to the present invention. FIG. 53B is a side view and FIG. 53C is and end view of the support of FIG. 53A.

FIGS. 54A-59 are perspective views of screen assemblies according to the present invention.

FIGS. 60A and 60B are crossectional views of hollow tubular members for supports according to the present invention.

FIGS. 61A and 61B are side views of part of a tubular member of a support according to the present invention. FIG. 61C is a crossectional view along line 61C-61C of FIG. 61B.

FIG. 62 is a perspective view of support according to the present invention.

FIG. 63A is a top perspective view of a design for a support according to the present invention. FIG. 63B is a bottom view, FIG. 63C is a side view, FIG. 63D is a side view (side opposite the side shown in FIG. 63C), FIG. 63E is an end view, and FIG. 63F is an end view (end opposite the end shown in FIG. 63E) of the support of FIG. 63A.

FIG. 64 is a side schematic cross-section view of a shale shaker with screen assemblies according to the present invention.

### DESCRIPTION OF EMBODIMENTS PREFERRED AT THE TIME OF FILING FOR THIS PATENT

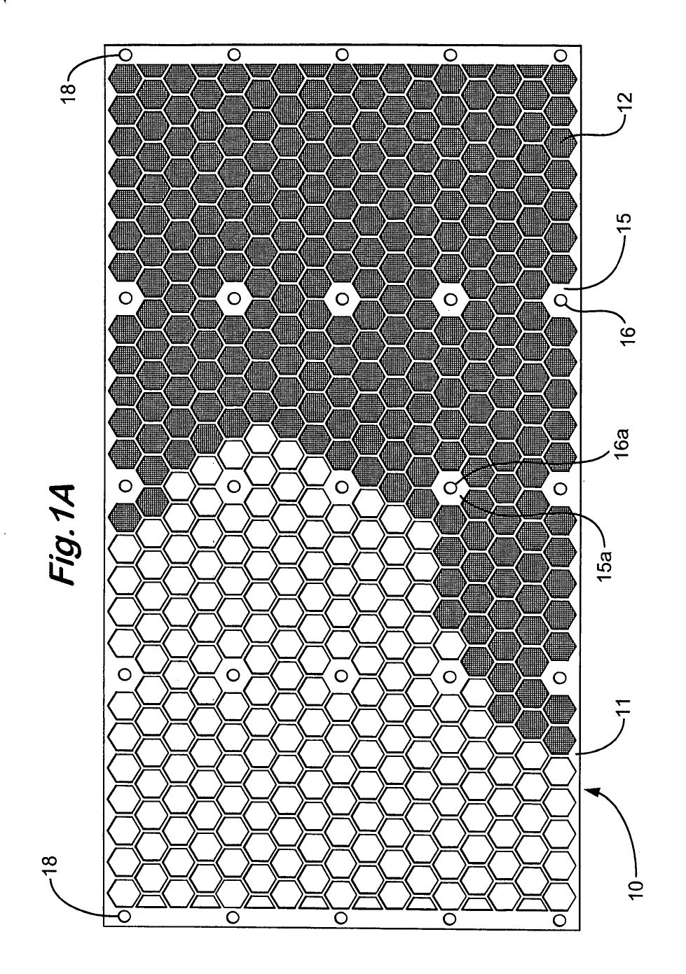

FIGS. 1A and 1B show a screen assembly 10 according to the present invention which has a perforated plate 11 on which is mounted three layers 12 of mesh or screening material. One, two, four, or more layers of screening material may be used. The plate 11 has a plurality of side holes 18 on each of two of its sides for receiving releasable fasteners for mounting the screen 10 in a suitable shale shaker. Optionally, the screen assembly's plate 11 may also have inner portions 15 with holes 16 therethrough and/or inner portions 15a with interior holes 16a therethrough which holes are also for receiving releasable fasteners for releasably connecting the screen assembly to the shale shaker. To insert the fasteners through the holes 16, 16a and 18 into holes in a deck or bed below a screen assembly, corresponding and appropriate holes or openings are made in the screening material. Although the entire inner portions 15a are revealed in FIG. 1A, in an actual screen assembly, prior to making holes in screening material, the holes 16a and inner portions 15a are covered by screening material.

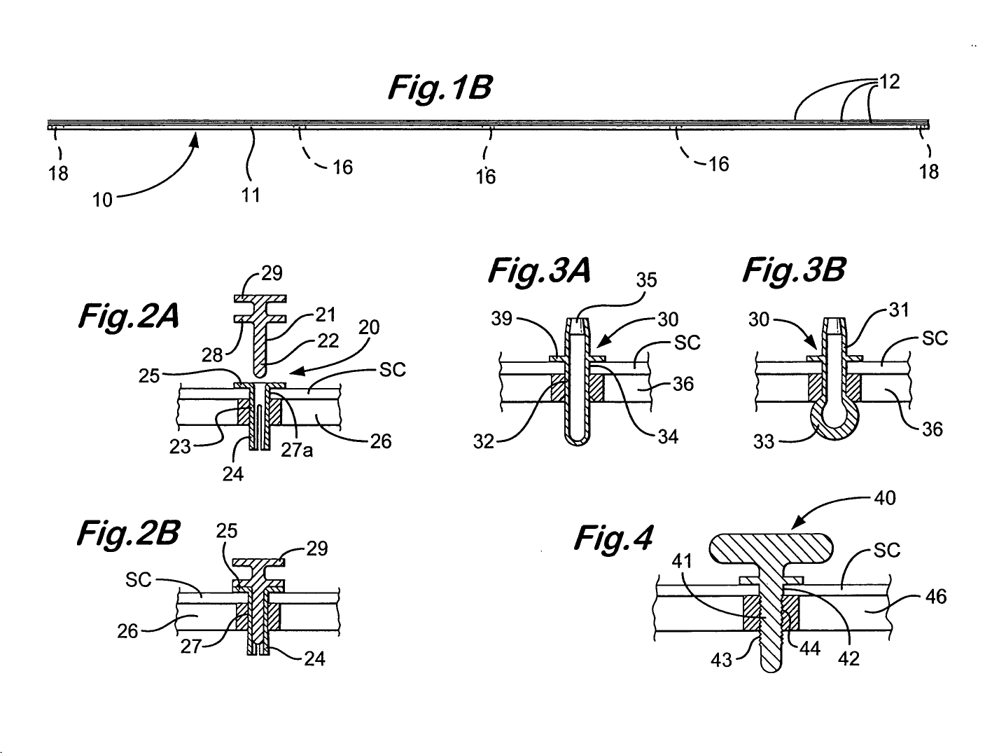

FIG. 2A shows a fastener system 20 according to the present invention which has a top member 21 with a lower portion 22 that is received within a bottom member 23 which has a plurality of spaced-apart fingers 24. Th lower portion 22 upon insertion into the bottom member 23 forces the fingers 24 apart for a tight friction fit of the lower portion 22 within the bottom member 23. An upper shoulder 25 of the bottom member 23 abuts the top surface of a screen assembly SC which may be any screen assembly according to the present invention. A shale shaker deck 26 has a hole 27 corresponding to a hole 27a through the screen assembly SC through which is mounted the bottom member 23. Any fastener hole in any screen assembly or part thereof according to the present invention and/or any corresponding hole through a shaker deck according to the present invention may have any desired opening shape as viewed from above, including, but not limited to, rectangular, triangular, elliptical, oval, pentagonal, circular, and hexagonal.

FIG. 2B shows the fastener system 20 releasbly holding the screen assembly SC to the shaker deck 26. Spaced apart shoulders 28 and 29 of the top member 21 provide an abutment against the screen assembly SC (the bottom shoulder 28) and a structure (the top shoulder 29) to grasp or contact to facilitate removal of the fastener.

FIGS. 3A and 3B show another embodiment of a fastener system according to the present invention for releasably connecting a screen assembly to a shale shaker. A system 30 has a fastener 31 with a body 32 and a lower inflatable member 33. A stop shoulder 39 on the body 32 abuts the top of a screen assembly SC (like that of FIG. 2A). Following insertion of the body 32 through a hole 34 in the screen assembly SC (see FIG. 3A), the inflatable member 33 is inflated through valve apparatus 35 to hold the fastener (and thus the screen assembly) in place. To release the fastener, the valve apparatus is activated to allow air to escape from the inflated inflatable member 33. The inflatable member 33 is sized and positioned so that, upon inflation, it abuts an underside of the deck 36 (like the deck 26, FIG. 2A) of a shale shaker.

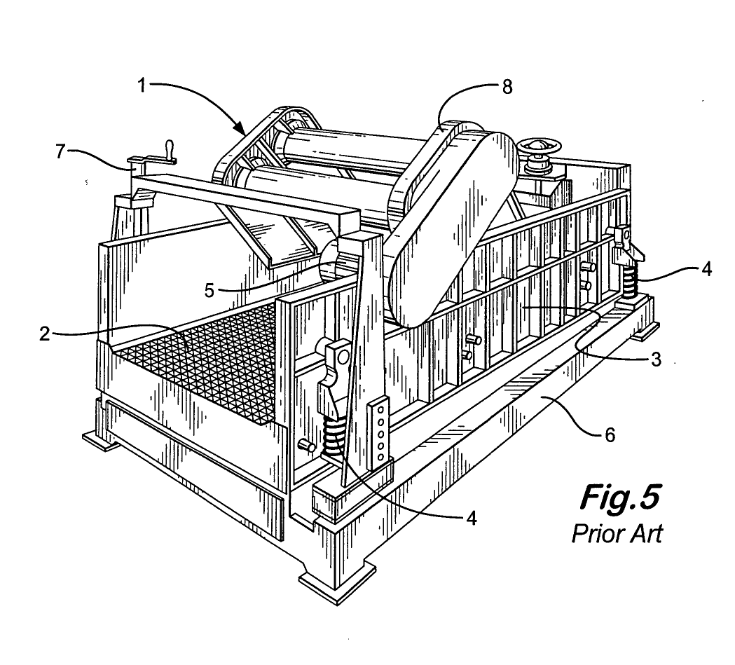

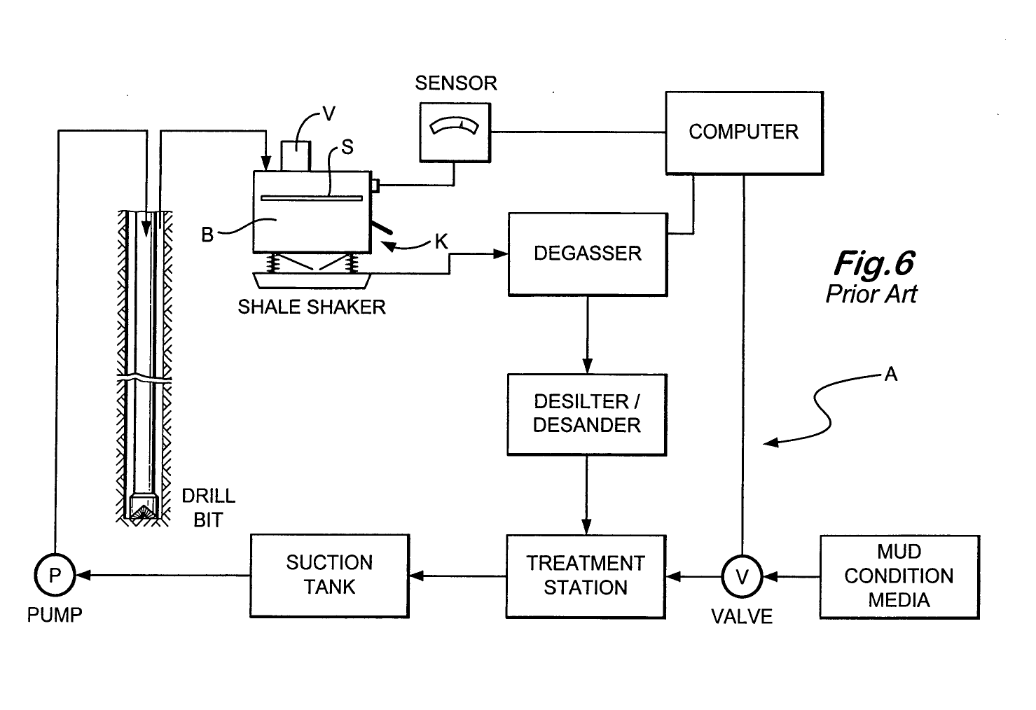

FIG. 4 shows a fastener 40 for releasably connecting a screen assembly SC (like that of FIG. 2A) to a shale shaker with a deck 46 (like the deck 26, FIG. 2A). The fastener 40 has a body 41 that is inserted through a hole 42 in the screen assembly SC. Optional threads 43 on the fastener body 41 mate with corresponding threads 44 on the deck 46 to releasbly hold the fastener, and thus the screen assembly, in place. Any fastener according to the present invention and any deck according to the present invention may have such threads. Optionally, the threads are deleted and the fastener is held in place with a friction fit; and/or, glue, epoxy, or an adhesive is used to hold the fastener in position (as may be done, optionally, with any other fastener disclosed herein); or a non-threaded locking fastener is used with required holes and/or surfaces on the shaker deck or bed. Any suitable screw or bolt may be used for the body 41. Optionally, the fastener 40 has a top head 45 that facilitates turning of and removal of the fastener 40. Any fastener in FIGS. 2A-4 may be used with any screen assembly disclosed herein.

It is within the scope of this invention for the screen assembly SC to have one, two, three or more layers of screening material, i.e., screen, mesh, and/or cloth made, e.g., of stainless steel wire and/or plastic. Any such layer or combination of layers may be bonded together (glued, welded, and/or sintered) in any known manner and/or bonded to the plate 11 in any known manner. Any such layer or layers of screening material may be substantially flat or may be undulating (with a series of alternating ridges and valleys) as is well known in the art. According to the present invention any known support, plate, strip support, or frame for supporting a shale shaker screen and/or for mounting thereto of one or more layers of screening material, mesh, and/or cloth may have one or more holes for receiving one or more fasteners according to the present invention for releasably connecting a screen assembly to a shale shaker.

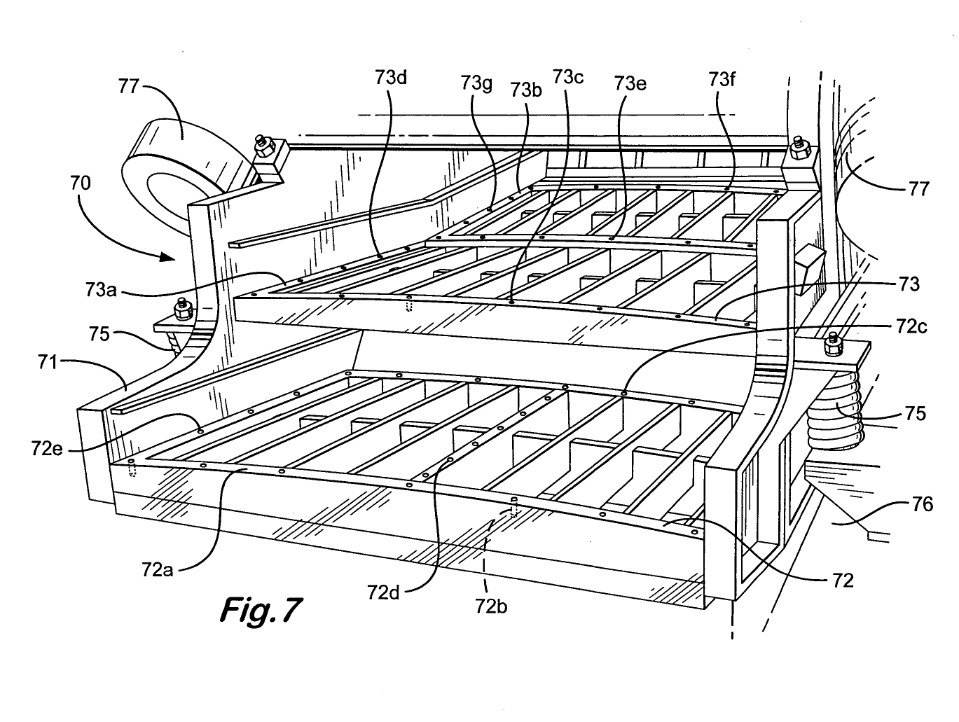

FIG. 7 shows a shale shaker 70 according to the present invention which is like a shaker disclosed in U.S. Pat. No. 5,641,070 co-owned with the present invention and incorporated fully herein for all purposes; but the shaker 70 has a basket 71 with screen mounting decks 72 and 73. Supports 72a and 73a of the decks 72 and 73, respectively, have holes 72b, 72c, 72d and 72e therethrough (in deck 72) and 73a, 73b, 73c (in deck 73). As desired such holes may be provided on all sides and/or on all cross-members of either or both decks. These holes are sized and positioned to correspond to holes in a screen support (and, optionally, holes through screening mesh and/or cloth) of screen assemblies (not shown) to be mounted in the basket 71. Springs 75 (two shown; four, six or more may be used) support the basket in a shaker body 76 and one or more vibrators 77 connected to the basket 71 vibrate the basket 71. Holes as in either or both decks 72, 73 may be provided for the deck(s) of any known multi-deck shale shaker so that screen assemblies according to the present invention with holes according to the present invention may be releasably fastened thereto.

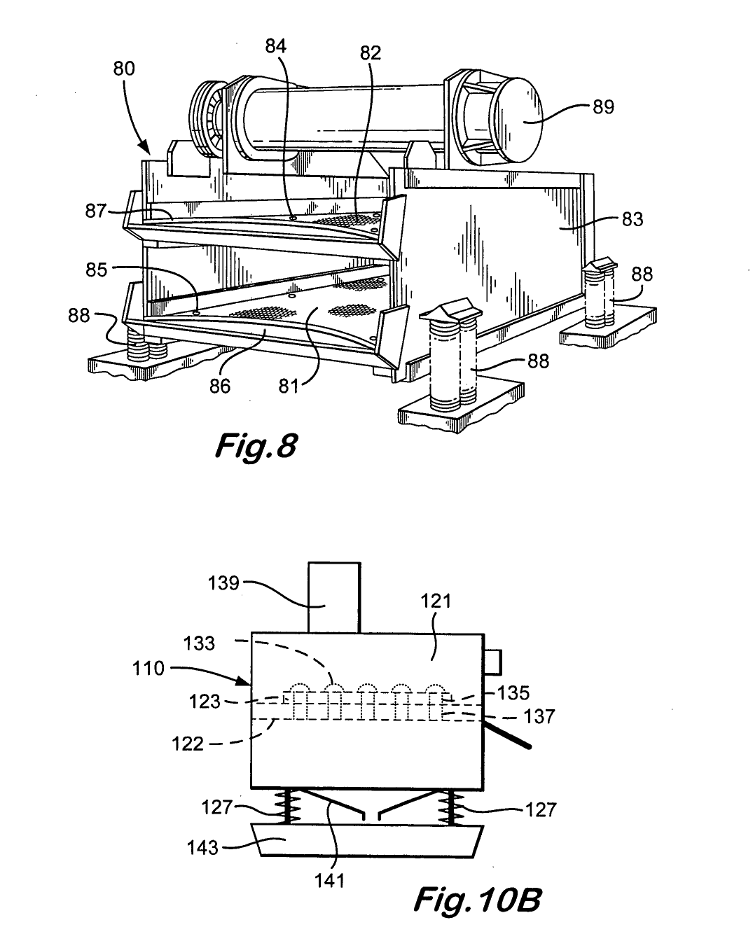

FIG. 8 shows a shale shaker 80 according to the present invention with screen assemblies 81, 82 according to the present invention mounted in a basket 83 to decks 86, 87 with fasteners 84, 85 which may be any screen assembly disclosed herein according to the present invention. The fasteners 84, 85 extend through holes (not shown) in the screen assemblies into holes (not shown) in the decks 86, 87. The basket 83 is mounted on spring mounts 88 (three shown; four used in this embodiment) and is vibrated by a vibrator 89.

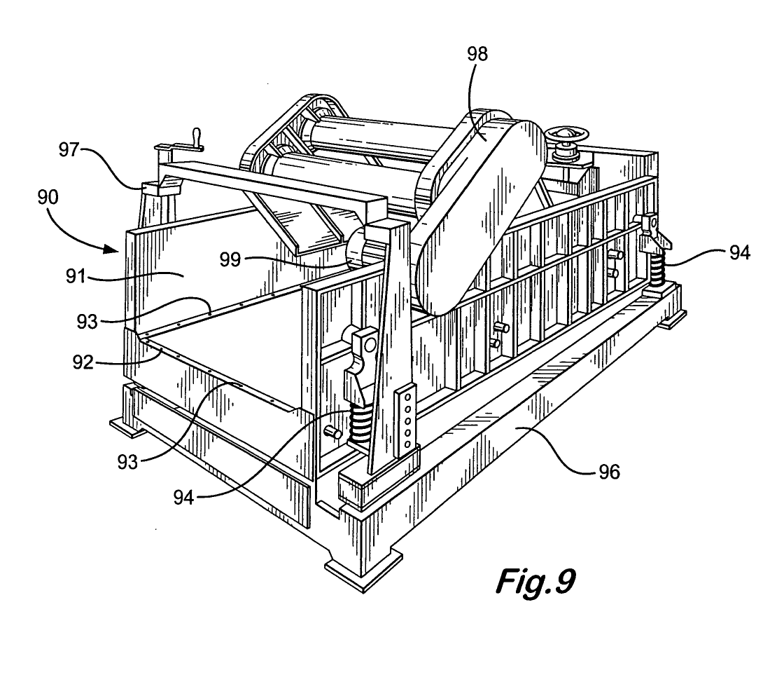

Referring now to FIG. 9, a shale shaker 90 according to the present invention has a screen deck 92 according to the present invention in a basket 91. The deck 92 has holes 93 therearound into which are releasably inserted fasteners (not shown; including, but not limited to, fasteners as disclosed herein and/or fasteners according to the present invention) to releasably secure one or more screen assemblies (not shown) to the deck 92. Any screen according to the present invention may be used on the deck 92. The basket 91 is mounted on springs 94 (only two shown; two as shown are on the opposite side) which are supported from a frame 96. The basket 91 is vibrated by a motor 99 and interconnected vibrating apparatus 98 which is mounted on the basket 91 for vibrating the basket and the screens. Optional elevator apparatus 97 provides for raising and lowering of the basket end.

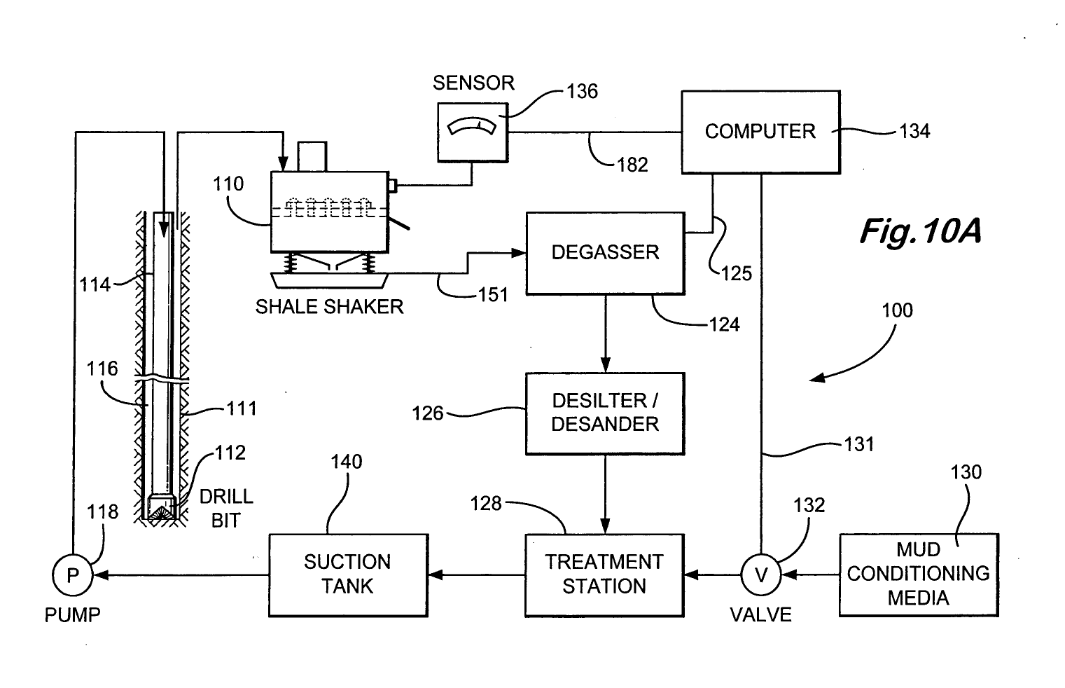

Referring now to FIGS. 10A and 10B a well 111 is being drilled by a bit 112 carried on a string of drill pip 114. Drilling mud is pumped by a pump 118 into the drill pipe 114 and out through nozzles in the bit 112. The mud cools and cleans the cutters of the bit and then passes up through a well annulus 116 flushing cuttings out with it.

After the mud is removed from the well annulus 116, it is treated before being pumped back into the pipe 114. First, the mud enters the shale shaker 110 where relatively large cuttings are re moved. The mud then enters a degasser 124 where gas can be removed if necessary. Degasser 124 may be automatically turned on and off, as needed, in response to an electric or other suitable signal produced by a computer 124 and communicated to degasser 124 as indicated by line 125. The computer 1344 produces the signal as a function of data from a sensor assembly 136 associated with shale shaker 110 and described more fully below. The data from sensor assembly 136 is communicated to computer 134 by line 182. The mud then passes to a desander and (or a desilter), jointly represented by station 126, for removal of smaller solids picked up in the well.

The mud next passes to a treating station 128 where, if necessary, conditioning media, such as barite, may be added from source 130. As shown, suitable flow control means, indicated in a simplified form by valve 132, controls flow of media from source 130 to station 128. Valve 132, in turn, may be automatically operated by an electric or other suitable signal produced by computer 134 as a function of the data from sensor assembly 136, such signal being communicated to valve 132 as indicated by line 131.

From the station 128, the mud is directed to tank 140, from which pump 118 takes suction, to be re-cycled through the well. Any shale shaker disclosed herein may be substituted for the shale shaker 110. The system 100 is like the systems disclosed in U.S. Pat. No. 5,190,645 (incorporated fully herein for all purposes), but the system 100 has a shake shaker according to the present invention.

The shale shaker 110 as shown in detail in FIG. 10B has a basket 121 in which a screen mounting deck 122 (shown schematically in FIG. 10B). A screen assembly 123 according to the present invention (shown schematically) is releasably secured to the deck 122 by a plurality of spaced-apart fasteners 133 which extend through holes 135 in the screen assembly 123 and through corresponding holes 137 in the deck 122. Vibrator apparatus 139 vibrates the basket 121 which is mounted on mounts 127. Material flows through exit structure 141 into a collection receptacle 143.

The screen assembly 123 may be any (one, two, three or more) screen assembly according to the present invention and the fasteners 133 may be any fastener according to the present invention.

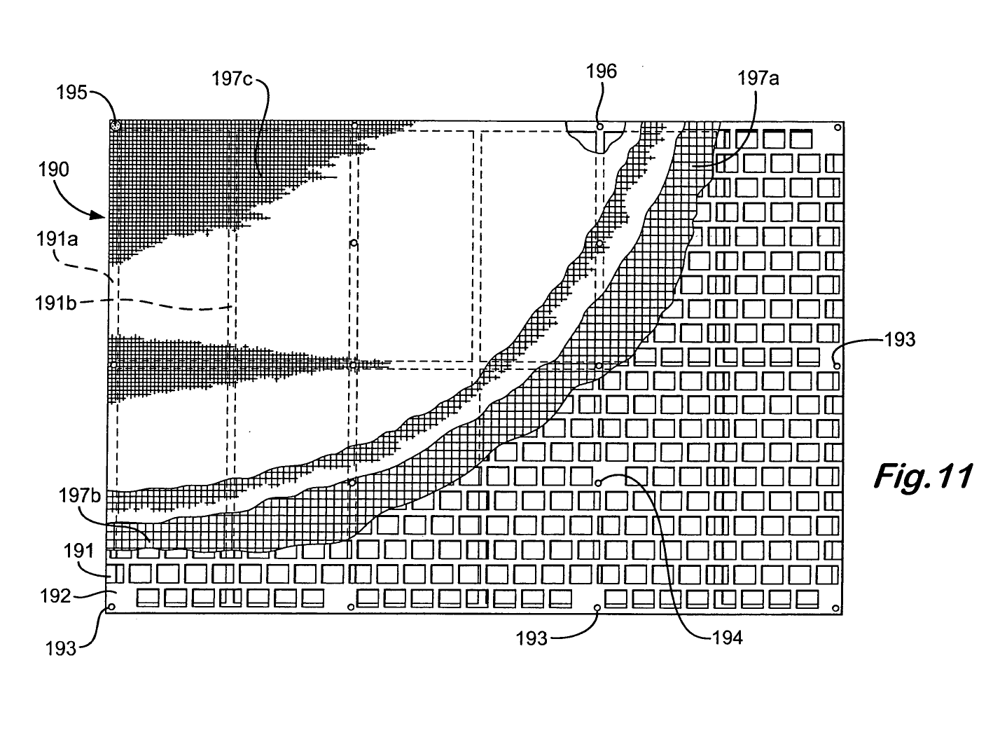

FIG. 11 shows a screen assembly 190 according to the present invention which has a lower tubular frame support 191 to which is connected and/or welded a perforated plate 192 (including, but not limited to a perforated plate like that disclosed in U.S. Pat. No. 4,575,421, incorporated fully herein for all purposes; but with holes according to the present invention for receiving fasteners according to the present invention to releasably connect the screen assembly 190 to a shale shaker).

The perforated plate 191 of the screen assembly 190 has a plurality of peripheral holes 193 and a plurality of interior holes 194 (either holes 193 or holes 194 may be deleted—as is the case for any support, plate, or frame according to the present invention). A plurality of fasteners 195 (two shown; one through each hole 193, 194) connect the plate 192 to the tubular frame support 191. The fasteners' lower ends are received in holes 196 of the tubular frame support 191 whose position corresponds to that of the holes 193, 194.

As shown in FIG. 11 there are three layers 197a, 197b, 197c of screening material on the plate 192. Any one or two of these layers may be deleted; any known combination of layers may be used; and the layers may or may not be connected and/or bonded together at their edges and/or across their surfaces in any known manner with any known material and/or process. Any known suitable tubular members may be used to make the tubular frame support 191 with its outer members 191a and its cross-members 191b.

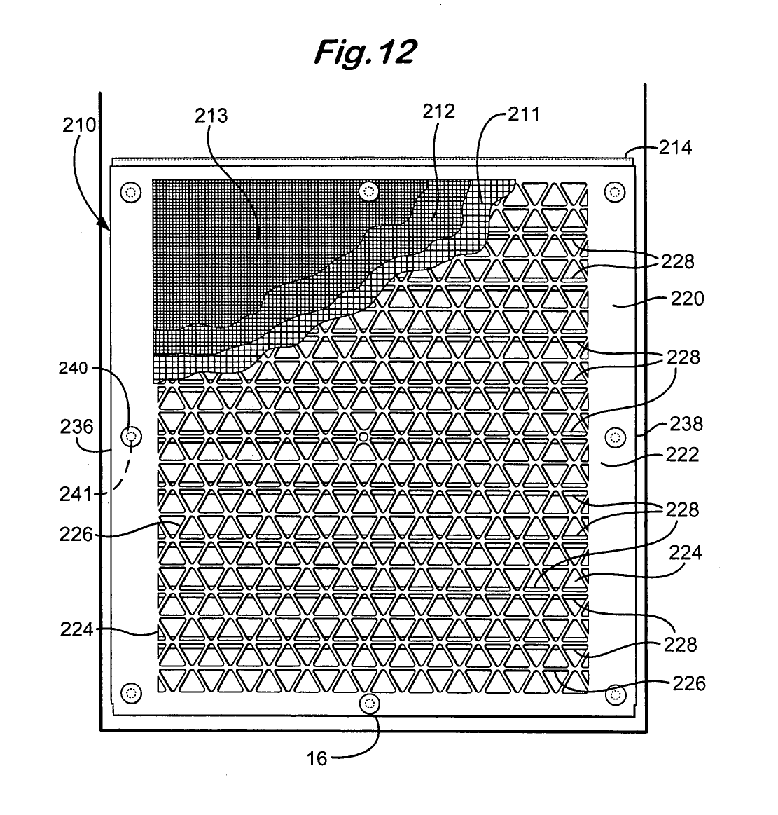

FIG. 12 shows a screen assembly 210 according to the present invention with a unibody structure 220 according to the present invention. The screen assembly 210 has, optionally, three 211, 212, 213 of screening material (shown partially; extending over the entire open area of the unibody structure 220) bonded to a top surface 222 of the unibody structure 220. Preferably, the layers 211, 212, 213 are also bonded together over substantially their entire surface area. A plurality of fasteners 240 extend through holes 241 in the unibody structure 220 to releasably connect the screen assembly 210 to a screen mounting deck 242 of a shale shaker (not shown in its entirety). Optionally, one or more fasteners 243 (one shown) may extend through the layers of screening material on the screen assembly 210 and into the deck 242.

A plurality of openings 224 through the unibody structure 220 define a plurality of support members 226. To the underside of the unibody structure 220 are, optionally, connected a plurality of spaced-apart ribs 228 which, in one aspect are welded to a metal unibody structure 220. In this particular embodiment the ribs 228 are positioned along a substantial majority of their length directly beneath one of the support members 226 that extend across a major portion of the unibody structure 220; but it is within the scope of this invention to use no such ribs or to position them anywhere on the underside of the unibody structure 220. The unibody structure 220 has spaced-apart sides 236, 238. The screen assembly 210 has an end 214 and a ledge end 216. The ledge end has an upper ledge portion that rests on a shoulder of an end of an adjacent screen. Thus one screen end seals against another screen end when such screens are used end-to-end (as described in U.S. Pat. No. 6,283,302 co-owned with the present invention as incorporated fully here for all purposes).

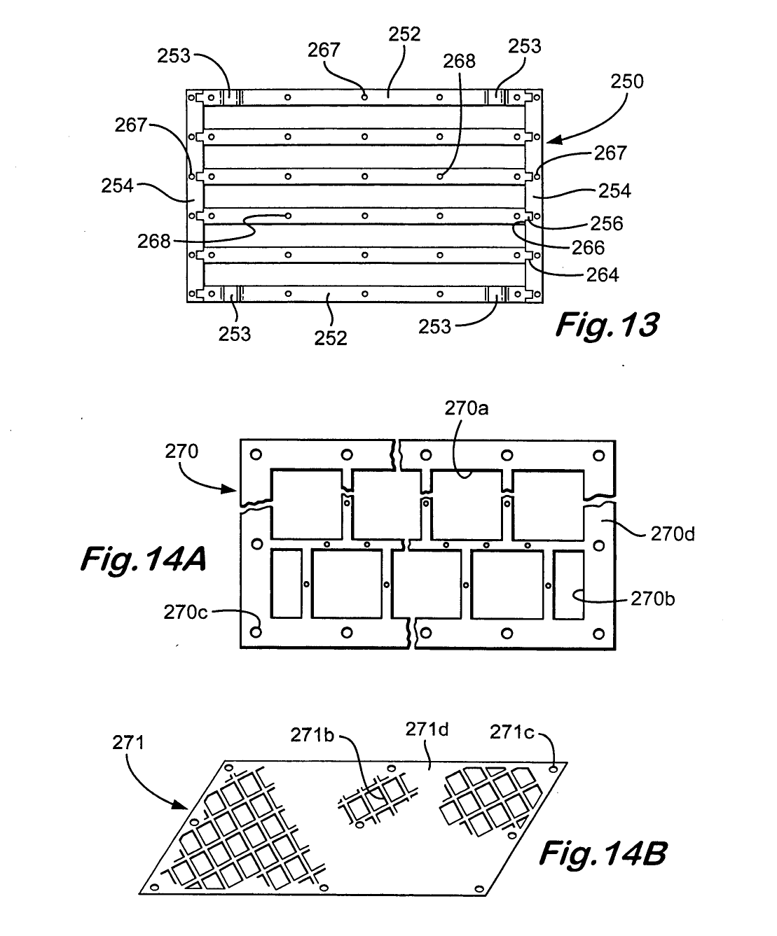

FIG. 13 shows a screen strip support 250, according to the present invention with a plurality of spaced-apart strips 252 (made of any suitable metal or metal-like material) secured to and between spaced-apart sides 254. The screen strip support 250 is like the strip support of FIG. 51A, U.S. Pat. No. 6,290,068 (co-owned wit the present invention and incorporated fully herein for all purposes); but the screen strip support 250 has outer holes 267 and inner holes 268 through which may be inserted any fastener disclosed herein for releasably connecting the support 250 (and any screen assembly of which it is a part) to a shale shaker deck. Either holes 267 or holes 268 may be deleted. Any known strip support may be provided, according to the present invention, with holes 267 and/or holes 268. Each end 256 of each strip 252 is received and held in a recess 264 in a side 254. The recess 264 corresponds in shape to the shape of the end 256 and a shoulder 266 of each strip 252 abuts a side 254. The end 256 may be inserted into the recess 254 from the side or from above or below. The top and bottom strips 252 each has two humps or ridges 253 which are located, sized, and configured to be received in corresponding corrugations of a corrugated plate and/or corrugated screen assembly. it is within the scope of this invention for each strip to have one, two, or a plurality of multiple humps or ridges. In one aspect there is one hump or ridge for each corrugation on a superimposed plate and/or screen assembly. It is within the scope of this invention to delete the humps and/or ridges so that the strips 252 are flat for use with flat mesh and/or screen(s).

FIGS. 14A and 14B show plastic grids 270, 271, respectively, each with a body 270d, 271d respectively with a plurality of openings 270a, 270b, 271b respectively, therethrough. Although only certain of the openings 271b are shown, it is to be understood they extend across the entire surface of the body 271d. The plastic grids 270, 271 are like plastic grids disclosed in U.S. Pat. Nos. 5,417,859; 5,958,236; 5,783,077; and 6,053,332 (all these patents incorporated fully herein for all purposes); but the grids 270, 271 each have a plurality of spaced-apart holes 270c, 271c, respectively therethrough for accommodating fasteners according to the present invention which extend through a screen assembly according to the present invention to releasably connect a screen assembly to a shale shaker. Any grid disclosed in the patents cited above and any known plastic grid or piece used in a screen assembly for a shale shaker may have holes as shown in FIGS. 14A and 14B (and/or any holes disclosed herein for any perforated plate or support disclosed herein); and any screen or screen assembly disclosed in the patents cited above may have any such grid or piece. Any such grid or piece according to the present invention may have holes corresponding to any fastener holes as described herein. In one aspect the holes in the grid or piece are made, according to the present invention, prior to the final formation or assembly of a screen or screen assembly (as may also be the case with any perforated plate or strip support according to the present invention); while in another aspect the holes are made through the plastic grid (and/or through other parts, pieces and/or layers of the screen or screen assembly) following final formation or assembly thereof (as may also be the case with any perforated plate, frame or strip support according to the present invention). It is to be understood that it is within the scope of the present invention to have a plastic layer or a mass of fusing plastic fusing together layers of screening material, the layer or mass optionally provided initially by a plastic grid, the plastic layer or mass having holes for fasteners corresponding to holes in a screening material support.

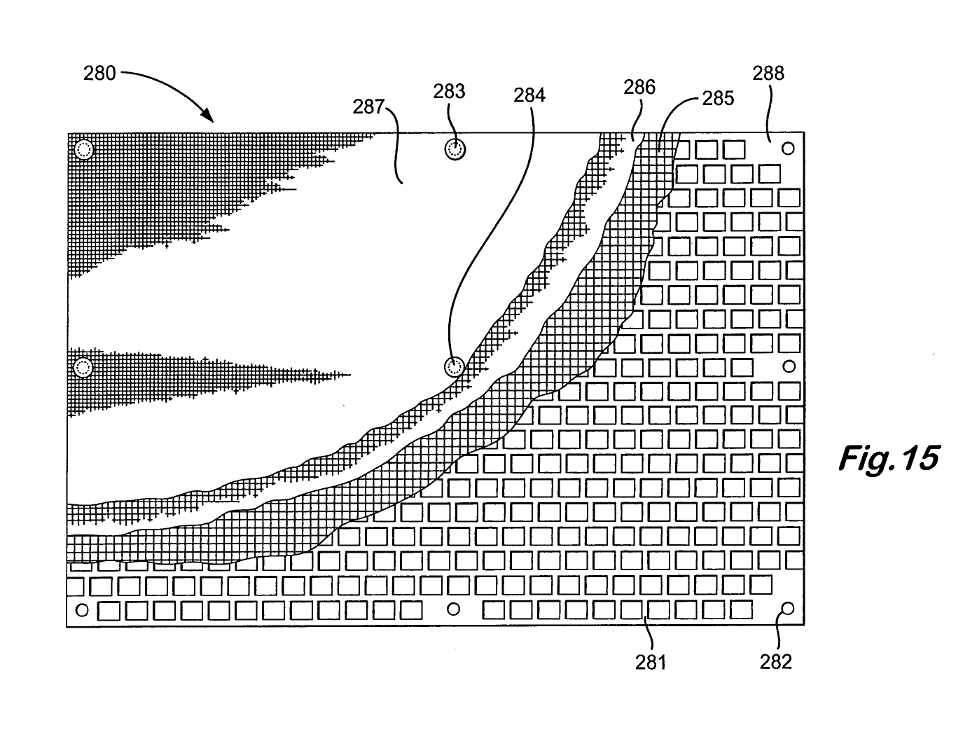

FIG. 15 shows a screen assembly 280 according to the present invention with a lower supporting perforated plate 281 according to the present invention. The screen assembly 280 is like those disclosed, e.g., in U.S. Pat. No. 4,575,421 (incorporated fully herein for all purposes; but without hookstrip mounting apparatus and with a plurality of peripheral holes 282 and one or more interior holes 284 for receiving fasteners 283 to releasably connect the screen assembly 280 to a shale shaker (not shown) whose deck or mounting structure has corresponding holes for releasably receiving a portion of the fasteners 283 (as is the case for a shale shaker and fasteners through any screen or screen assembly according to the present invention). In certain preferred aspects holes 282 and/or 284 are simply added to a perforated plate as shown in U.S. Pat. No. 4,575,421; while in other aspects the plate is initially made so that plate portions 288 have only a hole 282 or a hole 284. In one particular aspect (as is true for any perforated plate according to the present invention) an area like the areas 288 (and/or like the areas 15, FIG. 1A and/or like the areas around the holes 193, 194, FIG. 11 and for any plastic grid or piece according to the present invention) are at least as large (viewed from above) as one of the openings or perforations through the plate and in another preferred aspect are at least twice as large (viewed from above) as such an opening or perforation.

One, two, or three (or more) layers of mesh and/or screening material may, according to the present invention, be used on a perforated plate 280 (or on any perforated plate according to the present invention); e.g., as shown in FIG. 15, three layers 285, 286, and 287 are used on the plate 281. Although these layers are shown partially, it is to be understood they substantially cover the plate 281.

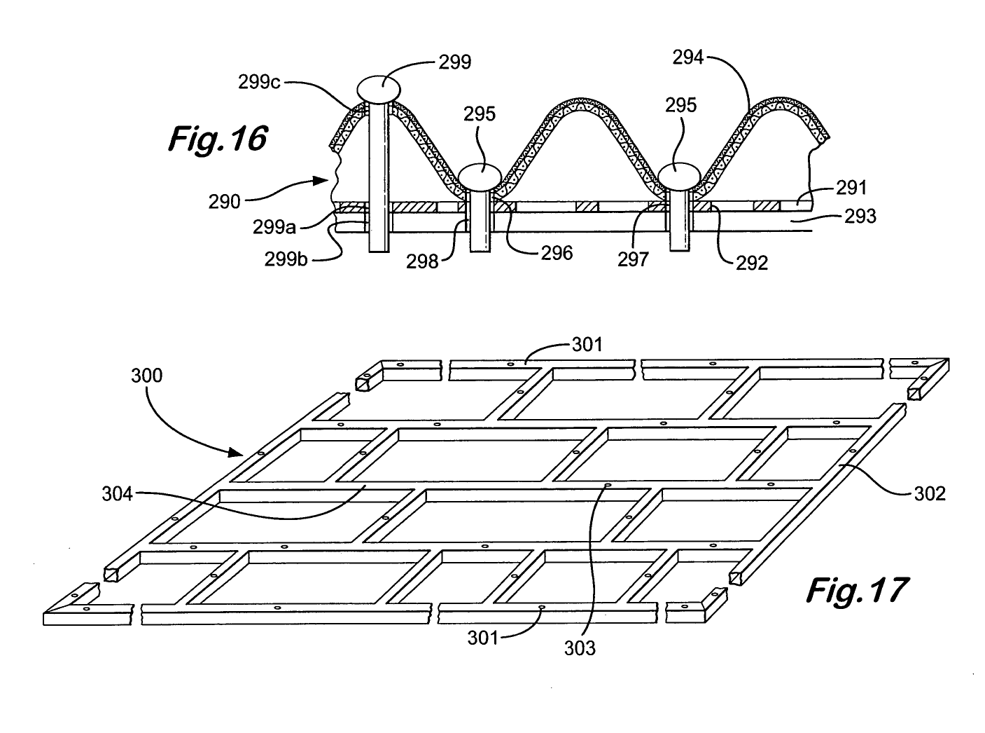

The prior art discloses a variety of non-flat screens and screen assemblies sometimes referred to as “3D” or “Three Dimensional” screens (e.g., but not limited to, as disclosed in U.S. Pat. Nos. 5,417,793; 5,417,858; 5,417,859; 6,053,332; 5,598,236; 5,783,077; 6,283,302; 6,290,068—all incorporated fully herein for all purposes). FIG. 16 illustrates that, according to the present invention, non-flat screen assemblies may be fastened with releasable fasteners passing through holes therethrough to a shale shaker. A screen assembly 290 (shown partially) has a lower perforated plate 291 (which, optionally, may be any support plate, frame, or strip support) with a plurality of spaced-apart openings 292 therethrough (see, e.g., but not limited to, FIG. 13, U.S. Pat. No. 5,417,858; and FIG. 3, U.S. Pat. No. 5,417,859 regarding possible plates and screening material). A plurality of fasteners 295 passing through holes 296 (in screening material 294), holes 297 (in the plate 291) and into (and, optionally, through) holes 298 (in a shaker deck 293).

As shown in FIG. 16, it is also within the scope of this invention to employ one or more fasteners 299 which extend through a portion of the screening material 294 that is not directly adjacent the plate 291 but which is spaced-apart therefrom. As shown a fastener 299 passes through a highest (with respect to the plate 291 as viewed in FIG. 16) portion of the screening material 294 and through holes 299a, and 299b, in the plate 291 and deck 293, respectively, and through a hole 299c in the material 2924; but it is within the scope of this invention to have one or more fasteners 299 (or 295) pass through any part or portion of the screening material 294. As may be the case with any fastener according to the present invention and any fastener used with a screen assembly according to the present invention, any suitable desired washer(s) and/or sleeve(s) may be used with the fastener(s) 295, 299 at any interface and/or for any hole.

It is within the scope of the present invention to provide holes for fasteners as disclosed herein in any known prior art frame used as a support for screening material for a screen assembly for a shale shaker. FIG. 17 illustrates a frame 300 according to the present invention which is like a frame as disclosed in U.S. Pat. No. 5,417,858, FIG. 8; but which has a series of outer holes 301 through tubular frame members 302 and, optionally, (or instead of the holes 301) holes 303 through interior tubular members 304. Any holes described herein for releasably fastening a screen assembly to a shale shaker may be used in the frame 300 or in any frame support for a shale shaker screen assembly. Any layer or layers of mesh or screening material described or referred to herein or known in the prior art may be used on the frame 300 or on any frame according to the present invention.

With screen assemblies according to the present invention (e.g. as in FIG. 1A) which employ no lower support frame, any opening through the lower support can receive a common plug to replace torn screening material above the opening and no frame member blocks any of the openings which could require a customized plug.

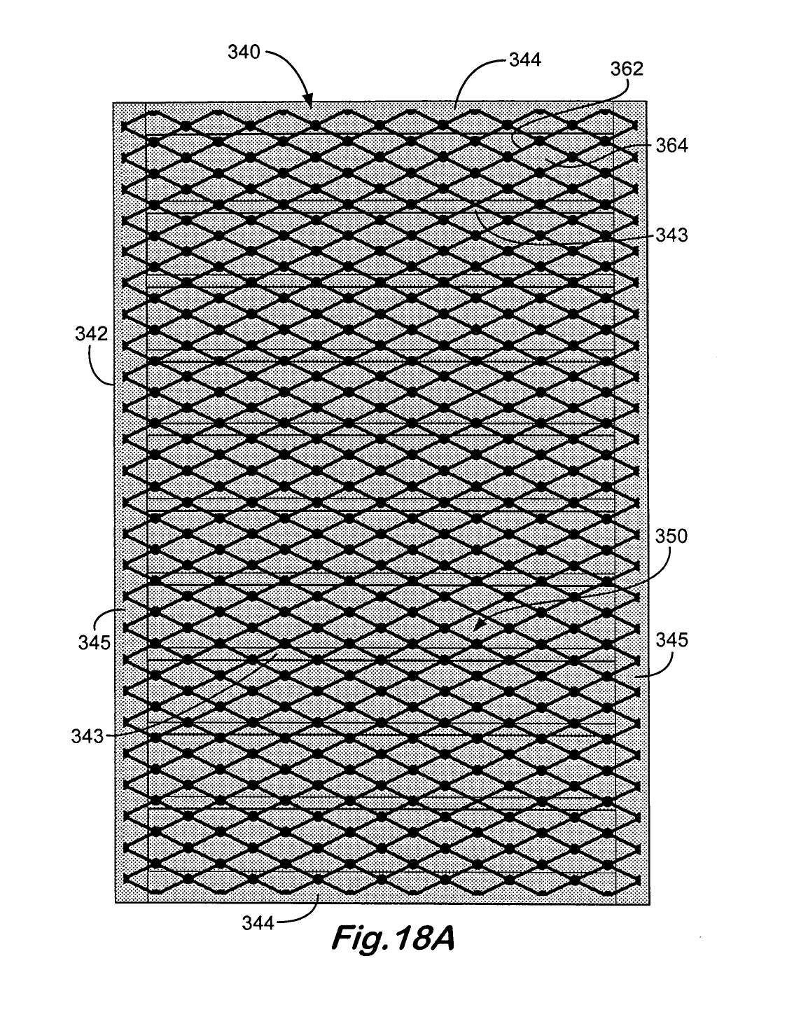

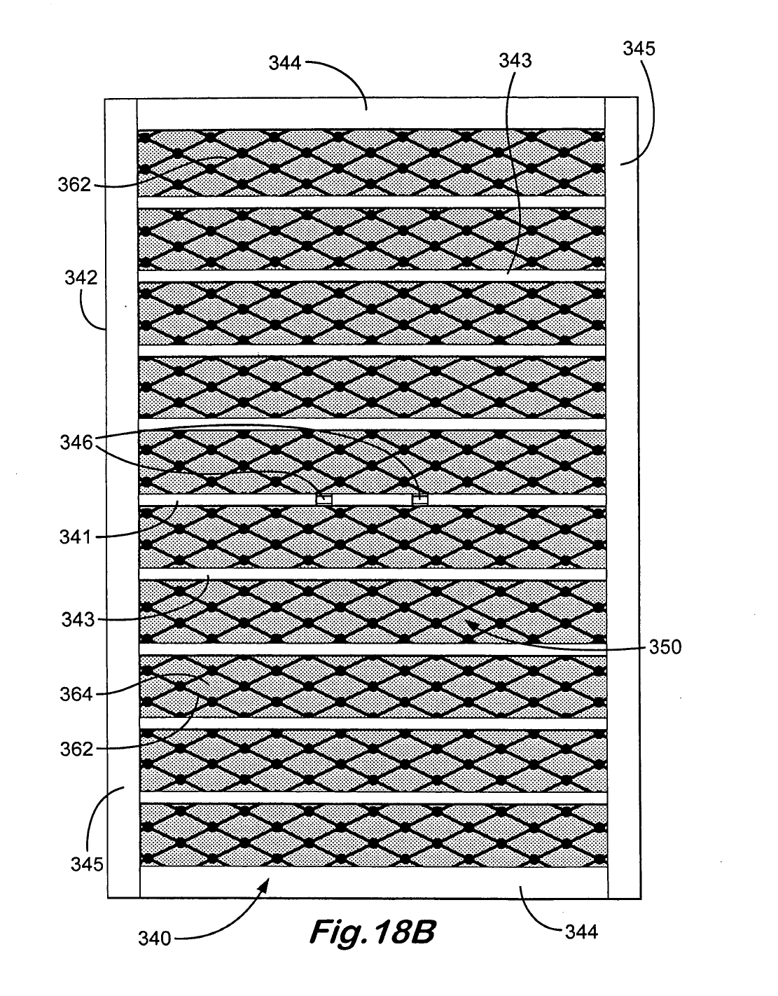

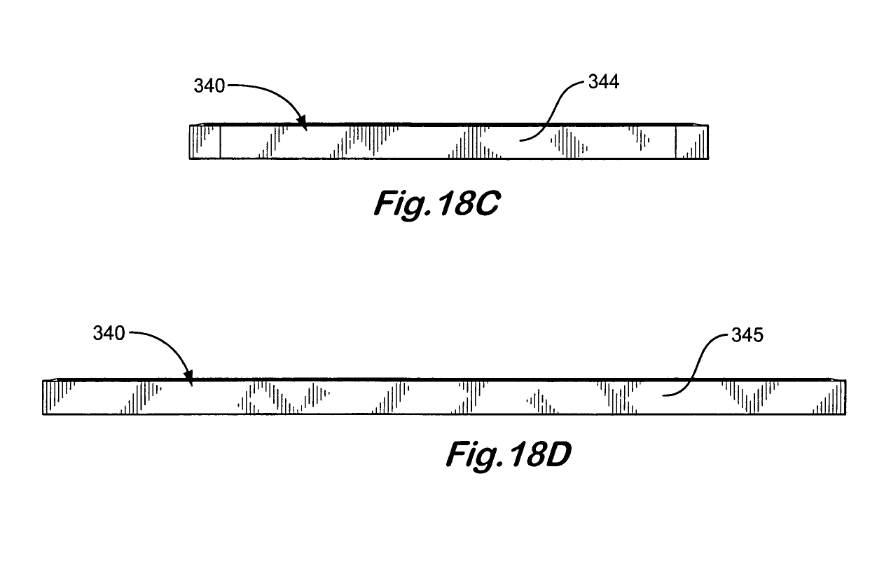

FIGS. 18A-18F show a screen assembly 340 according to the present invention which has a tubular frame 342 with ends 344 and interconnected sides 345. A screening material combination 350 is secured with cured epoxy to the tubular frame 342. A crossmember 341 (of a plurality of spaced-apart crossmembers 343 that extend between and have ends connected to the sides 345) has two notches 346, either of which is for receiving a portion of an upstanding member of a shale shaker deck.

In certain shale shakers in which screen assemblies without crossmembers such as the crossmember 341 are used, one or more upstanding members are located so that they do not push up on a screen assembly above them and such upstanding members are often used for proper screen assembly positioning, for preventing unwanted screen movement with respect to a shaker deck, or for stabilizing screen assemblies in position. Rather than removing such upstanding member(s) when a screen assembly is used that does have one or more crossmembers that would undesirably abut the top of an upstanding member (preventing correct screen assembly emplacement on a deck), a screen assembly according to the present invention may be installed on such a shaker deck so that a portion of the upstanding member (which is perpendicular to the crossmember 41 as viewed from above or below) is received in and projects into one (or more) of the notches 346. With a screen assembly 340 as shown, the crossmembers 343 on either side of the crossmember 341 are sufficiently spaced-apart from the crossmember 341 that the upstanding member does not contact the adjacent crossmembers 343. Although only one notch 346 can accommodate an upstanding member, by using two notches 346, proper emplacement of the screen assembly 340 over the upstanding member is made “fool proof”—i.e. whichever side of the screen assembly is placed nearest the shaker's exit end (or fluid introduction end) one of the notches will be above the upstanding member. Of course it is within the scope of the present invention to place aligned notches on adjacent crossmembers to accommodate an upstanding member of such dimensions that it extends beyond the distance separating two, three, four or more crossmembers. The screen assembly 340 as shown has a multi-layer combination 350 of layers of screening material glued together with moisture curing hot melt glue in a glue pattern 362. The multi-layer glued-together combination 360 is secured to the tubular frame 342 with cured epoxy.

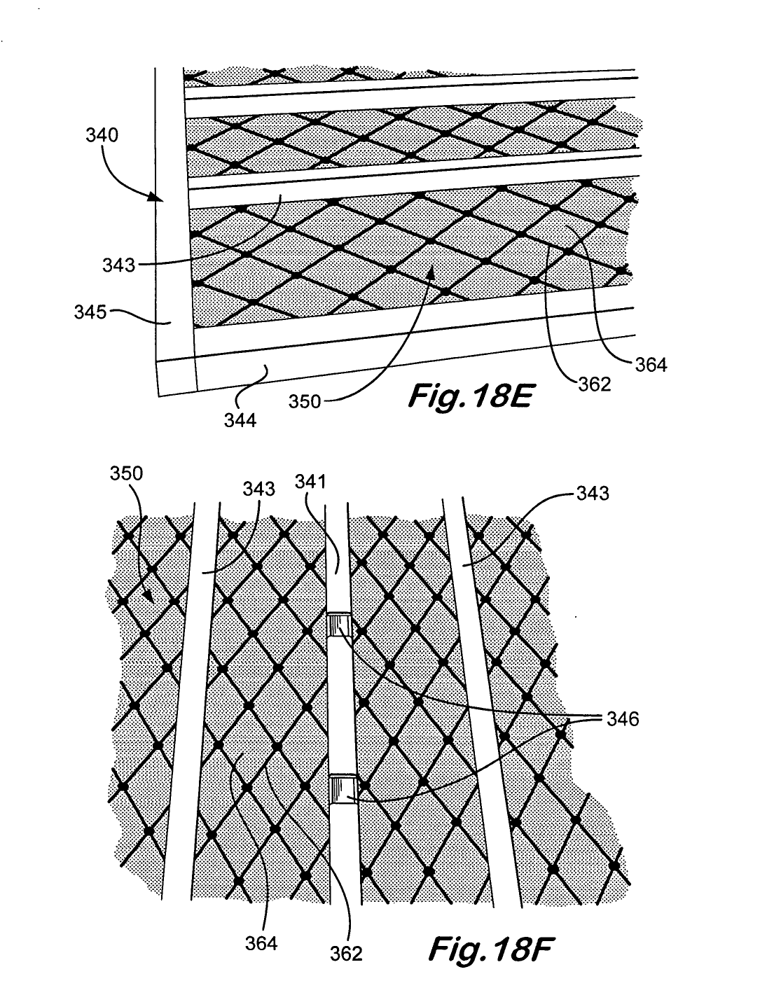

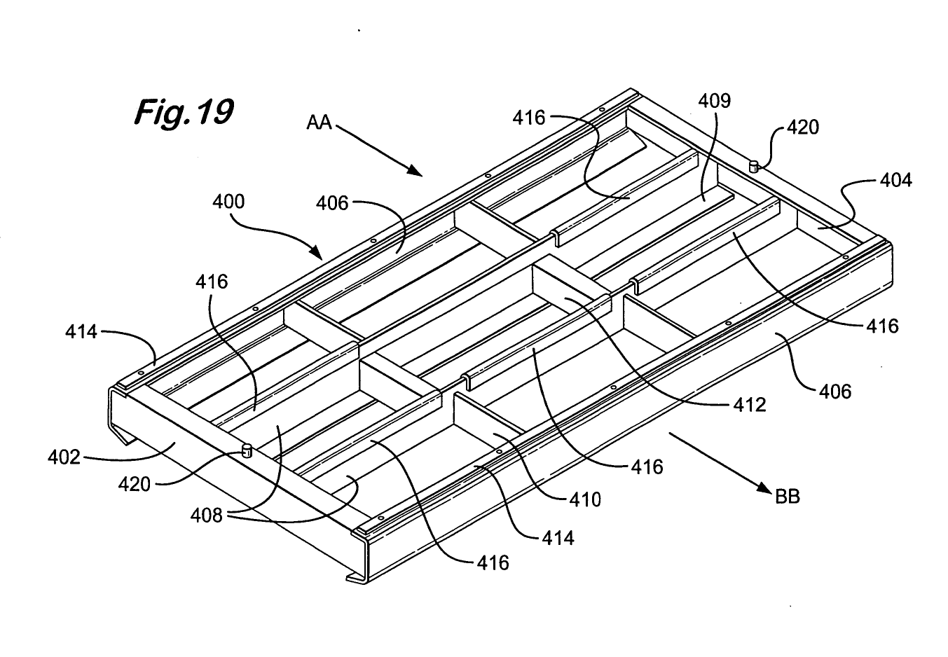

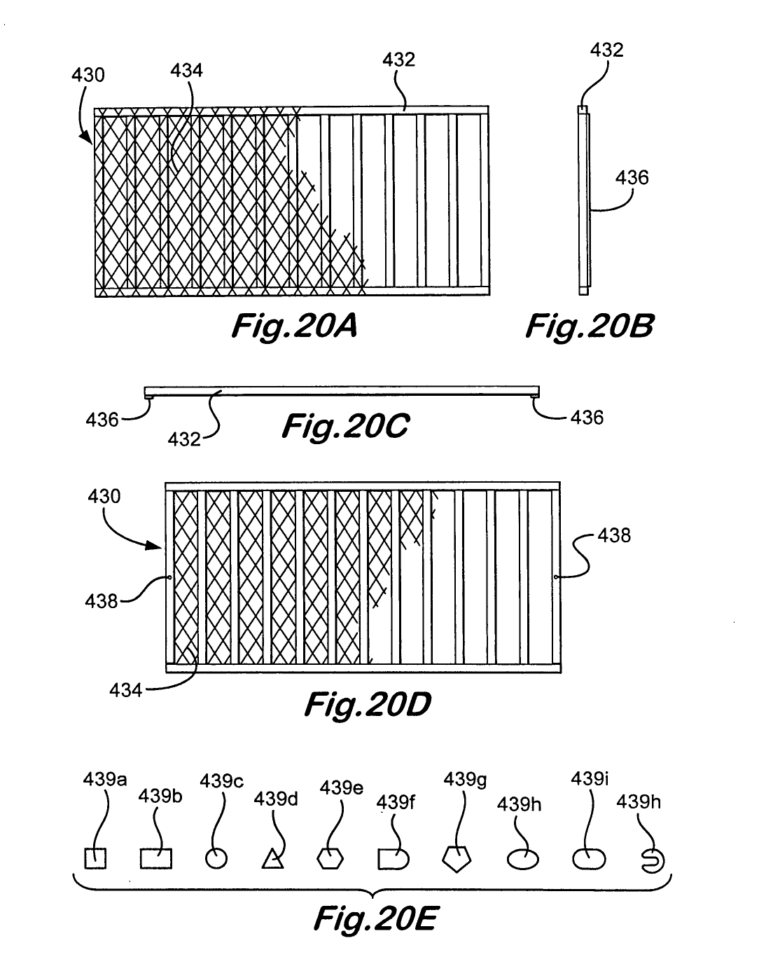

FIG. 19 shows a mounting structure (or “tray”) 400 for a shale shaker on which is releasably securable one or more screen assemblies. As shown a screen assembly mounts on and covers tray 400, but it is within the scope of this invention to have a larger tray on which two, three or more screen assemblies are secured or to have multiple trays 400 on a single shale shaker (as is true for any tray or mounting structure according to the present invention disclosed herein). Although a particular tray is shown in FIG. 19, it is to be understood that, according to the present invention, the teachings of the various holes and projecting members for trays (e.g., as in FIGS. 19-49) are applicable to known screen mounting structures for shale shakers in which and on which the holes and and upstanding members may be used; and similarly for the screen assemblies shown in FIGS. 20A-48 the various holes and projecting members may be used with any suitable known screen assembly.

The tray 400 has two spaced-apart outer ends 402, 404 which are spaced-apart by sides 406. The entire tray 400 is positioned in and connected to a basket or other suitable enclosure or housing of a shale shaker. Crossmembers 408 extend from end to end of the tray 400 and crossmembers 410, 412 extend between crossmembers 408 and sides 406. A support member 409 extends beneath one of the crossmembers 408 (and such a support may be under any crossmember). Wear strips 414 are connected to tops of the sides 406 and wear strips 416 are on tops of some of the interior crossmembers. An upstanding member 420 projects upwardly from each end 402, 404 of the tray 400. Each upstanding member 420 is located, sized, and configured for receipt within a corresponding hole of a screen assembly placed on the tray 400. Fluid to be treated by a shale shaker with a tray as in FIG. 19 (or any tray disclosed herein) may flow across a screen assembly placed on the tray in any desired direction; and one such direction is indicated by the arrows AA and BB in FIG. 19.

FIGS. 20A-20D show a screen assembly 430 according to the present invention which has a lower support frame 432 (which may be any known screen assembly support frame or which may, alternatively, be any known screen assembly support such as a strip support, perforated plate, or unibody structure). Screening material 434 (shown partially, but covering the frame 432) is on the top of the frame 432 and may be any known screening material used in screen assemblies for shale shakers, including, but not limited to, multi-layer screen meshes and/or flat or 3-D materials. A lower bar 436 is connected to or formed integrally of the frame 432 at each of its ends. Each end of the screen assembly 430 has a hole 438 for receiving a member projecting upwardly from a shale shaker's screen mounting structure, e.g., but not limited to, like the upstanding members 420, FIG. 19. The holes 438 do not extend through the top of the frame 432.

FIG. 20E shows possible shapes 439a, b, c, d, e, f, g, h, i and j as viewed from above, for any upstanding member or upwardly projecting member according to the present invention; for holes corresponding to such upstanding or upwardly projecting members; and for support or frame sides and/or crossmembers of any support or frame disclosed herein. Additionally such shapes can include an upright or inverted trapezoidal shape.

FIG. 21 shows a tray 440 according to the present invention which is like the tray 400 (and like parts are designated with the same numerals), FIG. 19; but which has three upstanding members 420 at each of its ends, each for receipt within corresponding holes of a screen assembly to be emplaced on the tray 400, Tray ends or sides according to the present invention may have any desired number of upstanding or upwardldy projecting members for receipt within corresponding holes of a screen assembly.

FIG. 22 shows a tray 450 like the tray 400 (and like parts are designated with the same numerals); but without any upstanding members 420 and with a hole 452 in each of its ends. The holes 452 are located, sized, and configured for receiving corresponding downwardly projecting members of a screen assembly emplaced on the tray 450.

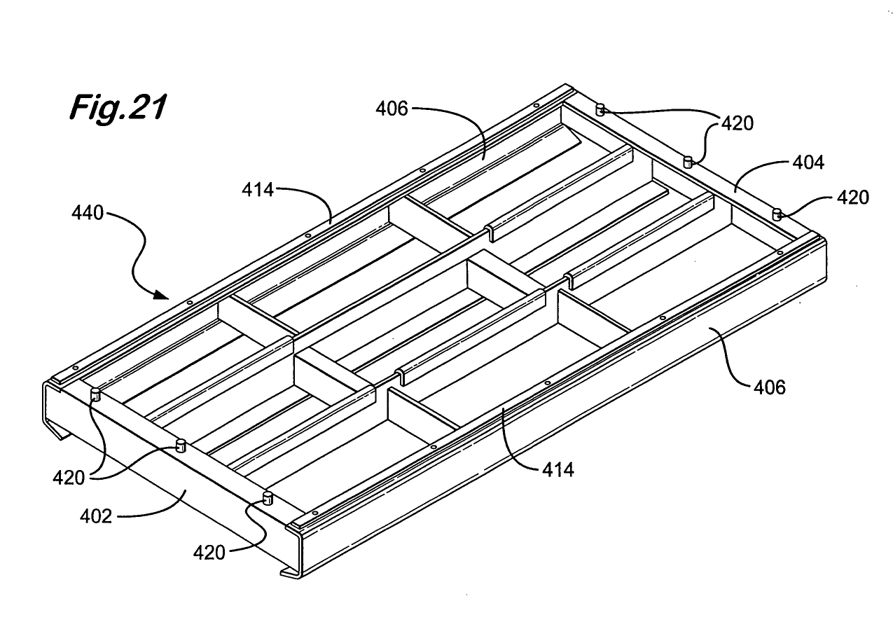

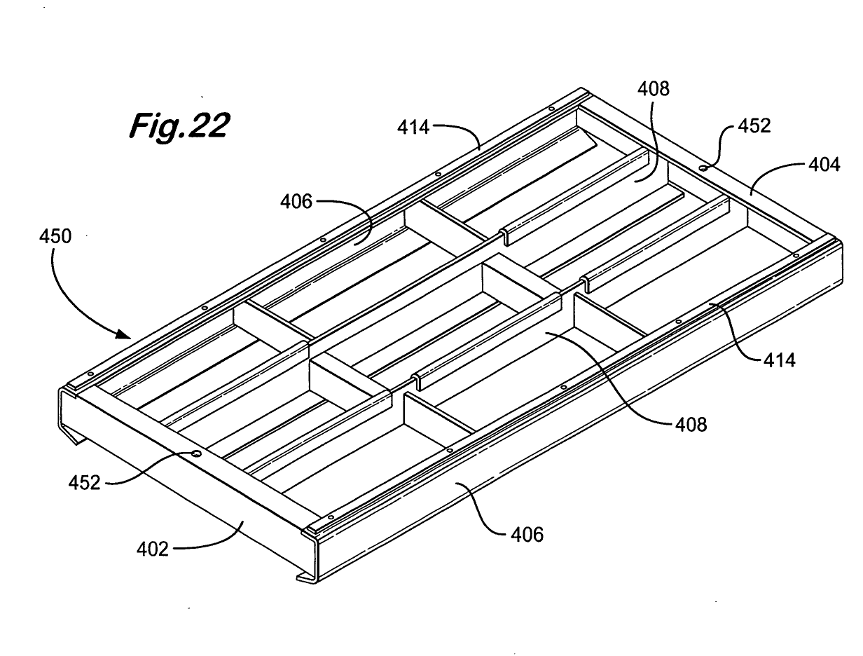

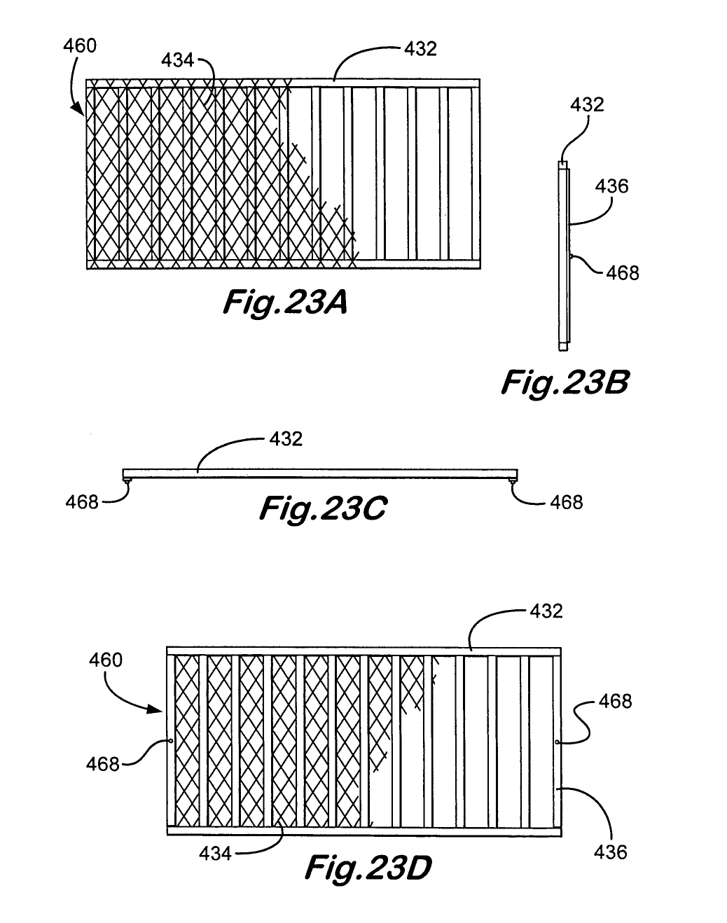

FIGS. 23A-23D show a screen assembly 460 according to the present invention like the screen assembly 430, FIG. 20A, and like numerals designate like parts. Instead of holes 438, however, the screen assembly 460 has downwardly projecting members 468 on each of its ends. The downwardly projecting members 468 are located, sized, and configured for receipt within corresponding holes in a shale shaker's screen mounting structure, e.g., but not limited to, such as the holes 452, FIG. 22.

FIG. 24 shows a tray 470 according to the present invention like the trays 400 (FIG. 19) and 450 (FIG. 22); but with two upstanding members 472 at each of its ends and a hole 474 in each of its ends. Each upstanding member 472 is located, sized and configured for receipt within a corresponding hole of a screen assembly and the hole 474 is located, sized and configured for receiving a corresponding downwardly projecting member of a screen assembly. Either one or both of the upstanding members 472 may be deleted; there may be three or more upstanding members 4742; the hole 474 may be deleted; and/or there may be two, three or more holes 474—as is true for any tray according to the present invention.

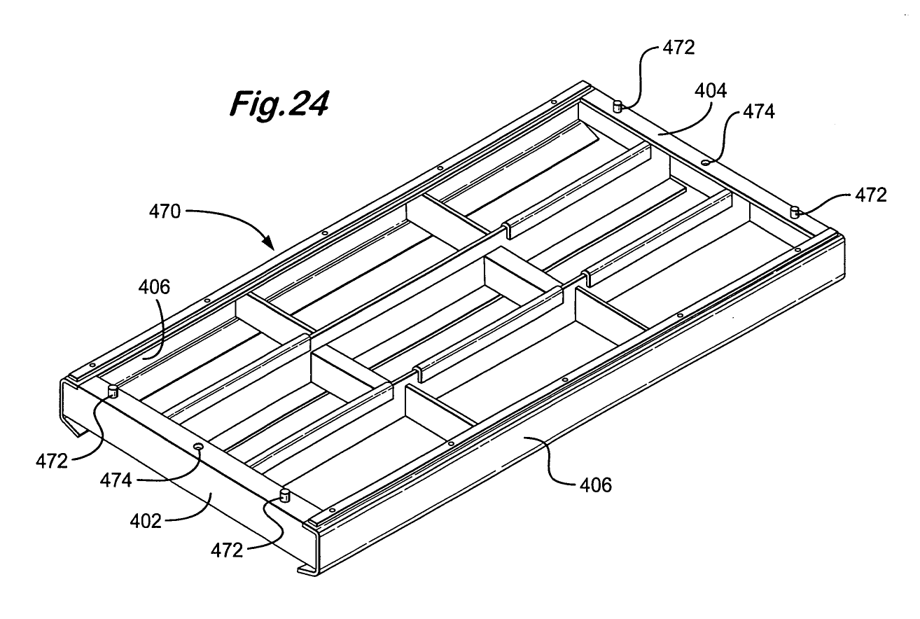

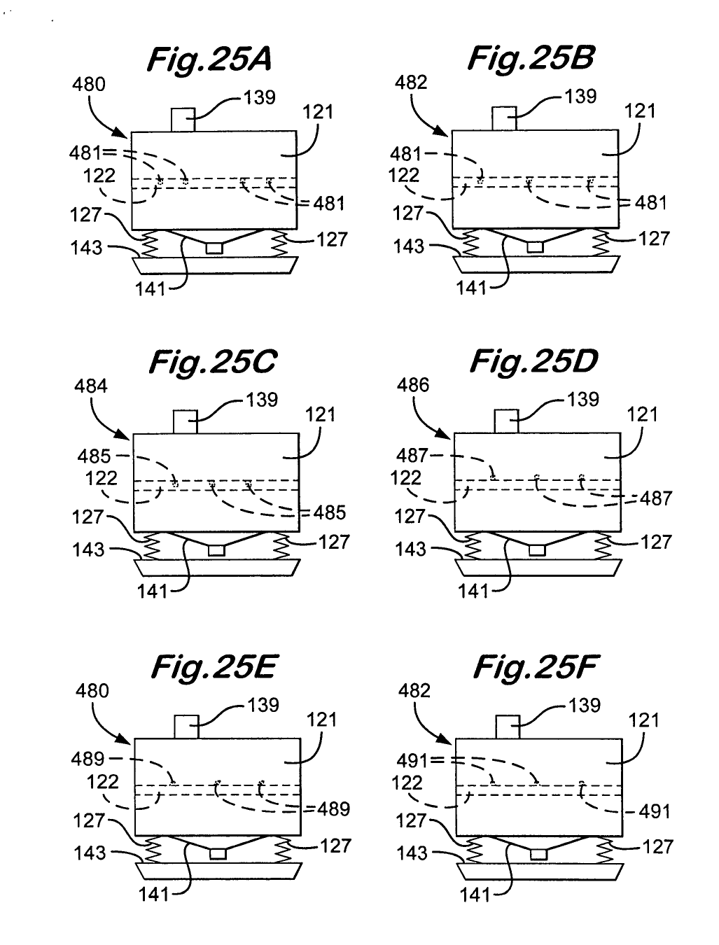

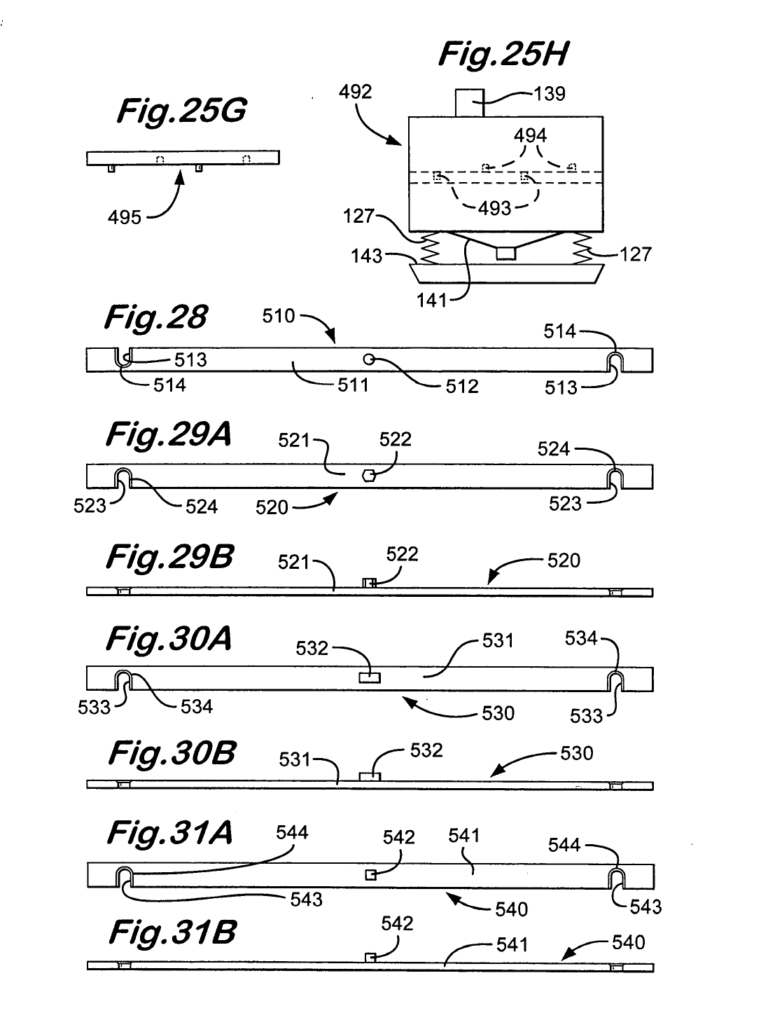

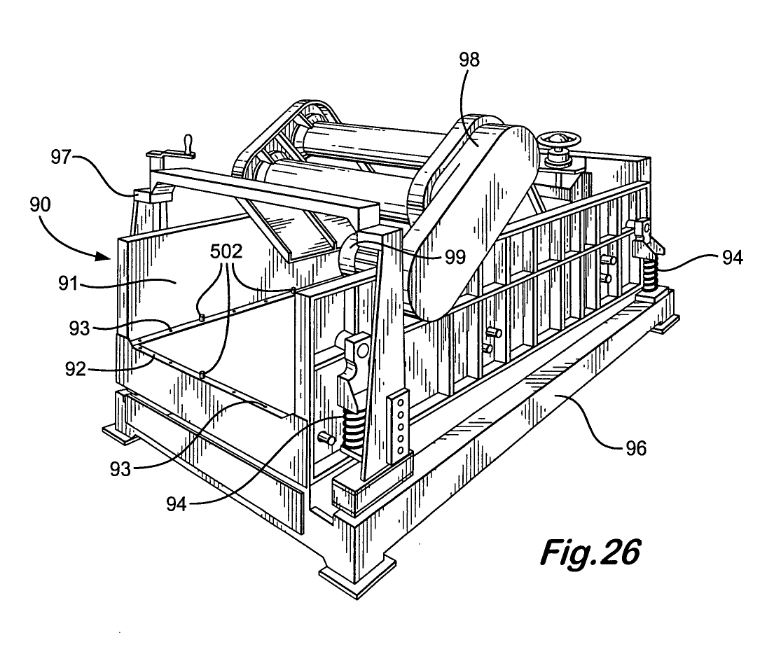

FIGS. 25A-25H show schematically shale shakers according to the present invention with shale shaker decks (screen mounting structures) according to the present invention. The shale shakers of FIGS. 25A-25H are like the shale shaker of FIG. 10B and like numerals designate the same parts. It is within the scope of the present invention to employ any of the holes or upstanding members in FIGS. 25A-26H on any shale shaker mounting structure disclosed herein. Also, any screen assembly disclosed herein can have the hole(s) and/or downwardly projecting members of the screen assembly of FIG. 25G. It is to be understood that although the drawings of FIGS. 25A-25H show upstanding members or holes at only one side of a deck, the other side (not shown) of the deck may have the same structure, or it may have none of the structure shown.

A shale shaker 480 shown in FIG. 25A has a plurality of spaced-apart holes 481, each hole for receiving a corresponding downwardly projecting member of a screen assembly placed on the shale shaker's deck. The holes 481 extend down substantially perpendicularly into the deck 122. Any number of holes 481 may be used (one—four or more).

A shale shaker 482 shown in FIG. 25B has a plurality of spaced-apart holes 483, each hole for receiving a corresponding downwardly projecting member of a screen assembly placed on the shale shaker's deck. The holes 483 extend down at an angle (toward the left) into the deck 122. Any number of holes 483 may be used (one—four or more) and they may extend into the deck 122 at any desired angle, including, but not limited to, angled toward or away from a fluid introduction end or fluid exit end.

A shale shaker 484 shown in FIG. 25C has a plurality of spaced-apart holes 485, each hole for receiving a corresponding downwardly projecting member of a screen assembly placed on the shale shaker's deck. The holes 485 extend down at an angle into the deck 122. Any number of holes 485 may be used (one—four or more) and they may be angled at any desired angle in any desired direction.

A shale shaker 486 shown in FIG. 25D has a plurality of spaced-apart upstanding members 487, each hole for receipt within a corresponding hole of a screen assembly placed on the shale shaker's deck. The upstanding members 487 extend up substantially perpendicularly to the deck 122. Any number of members 487 may be used (one—four or more).

A shale shaker 488 shown in FIG. 25E has a plurality of spaced-apart upstanding members 489, each for receipt within a corresponding hole of a screen assembly placed on the shale shaker's deck. The upstanding members 489 extend up at an angle to the deck 122. Any number of members 489 may be used (one—four or more) and they may project from the deck at any desired angle in any desired direction.

A shale shaker 489 shown in FIG. 25F has a plurality of spaced-apart upstanding members 491, each for receipt within a corresponding hole of a screen assembly placed on the shale shaker's deck. The upstanding members 491 extend up at an angle to the deck 122. Any number of upstanding members 491 may be used (one—four or more) and they may be at any desired angle in any desired direction.

A shale shaker 492 shown in FIG. 25H has a plurality of spaced-apart holes 493, each hole for receiving a corresponding downwardly projecting member of a screen assembly placed on the shale shaker's deck and a plurality of spaced-apart upstanding members 494 projecting up from the deck 122. The holes 493 extend down substantially perpendicularly into the deck 122 (but may be at any angle at any direction) and the upstanding members 494 project up substantially perpendicularly to the deck 122, but may be at any angle in any direction. Any number of holes and/or upstanding members may be used (one—four or more).

FIG. 25G shows schematically a screen assembly 495 according to the present invention, useful on a shale shaker, which has a body or support 496 with two spaced-apart downwardly projecting members 497 and two spaced-apart holes 498. The downwardly projecting members 497 are for receipt within corresponding holes (e.g. but not limited to, such as the holes 493, FIG. 25H) in a shale shaker screen assembly mounting structure; and the holes 498 are for receiving corresponding upwardly projecting members of a shale shaker mounting structure (e.g., but not limited to, such as the upstanding members 494, FIG. 25H).

FIG. 26 shows a shale shaker 500 like the shale shaker of FIG. 19 (like numerals indicate the same parts); but with a plurality of spaced-apart upwardly projecting members 502 projecting up from the deck 92. It is to be understood, although not shown, that as desired, upstanding members 502 may be provided spaced-apart on both sides or around the entire periphery of the deck 92 (or of any shaker deck). Optionally, the holes 93 may be deleted or they may be sized for receiving downwardly projecting members of a screen assembly.

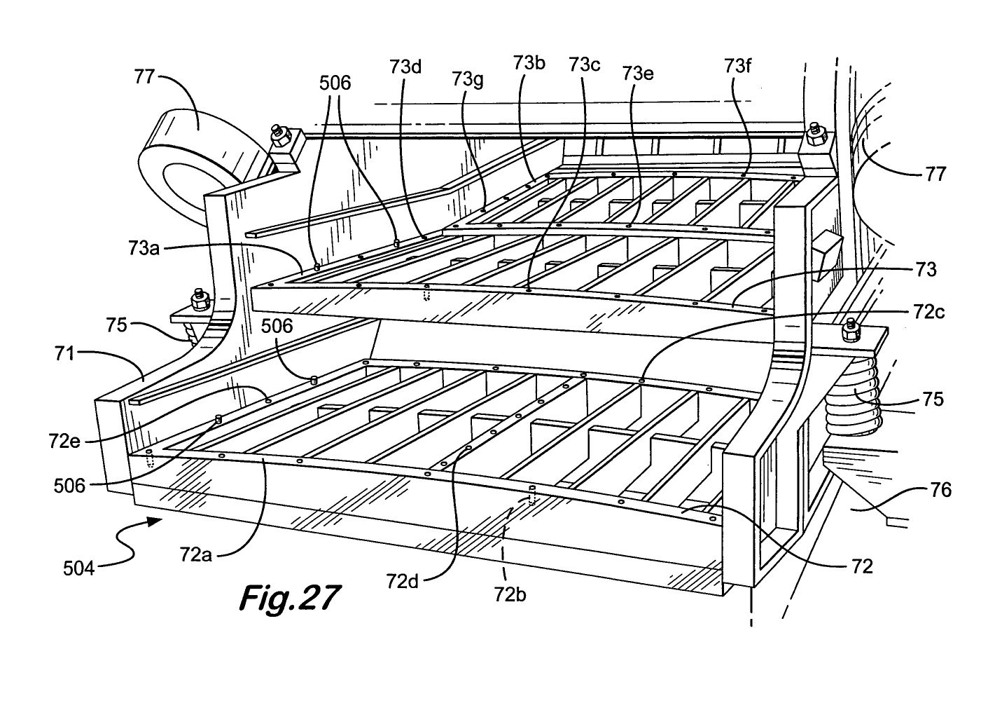

FIG. 27 shows a shale shaker 504 like that of FIG. 27 but with a plurality of spaced-apart upwardly projecting members 506 at the sides of the screen assembly mounting structures of the shale shaker. Optionally, the holes (or some of them) 72 and 73 may be deleted or they may be sized to receive a downwardly projecting member of a screen assembly.

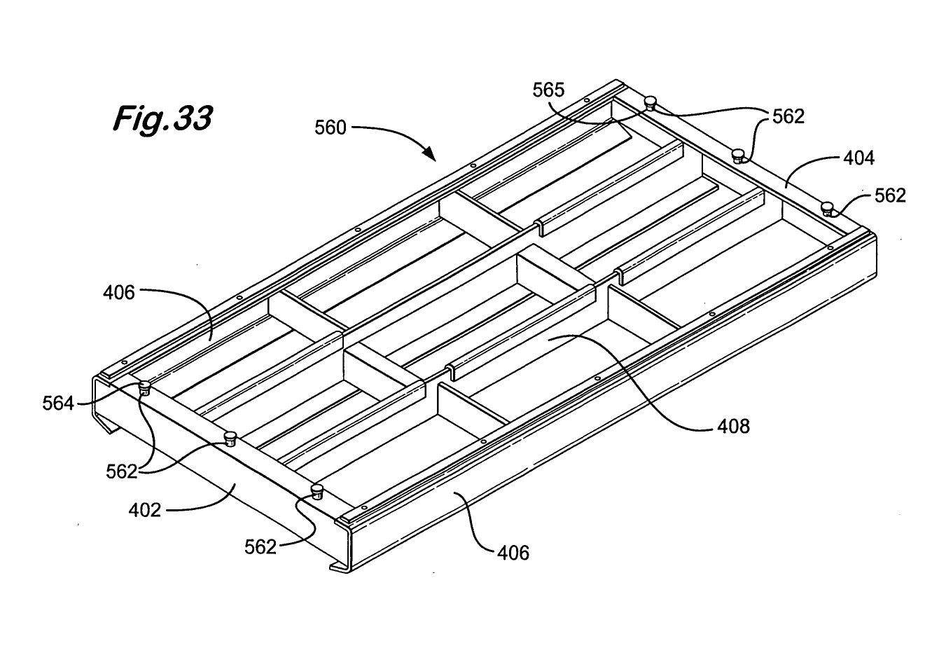

FIG. 28 shows a wear strip 510 according to the present invention which has a body 511 and an upstanding member 512 for receipt within a corresponding hole of a screen assembly. Using openings 513 at either end of the body 511, the wear strip 510 is connectible to an end or side or crossmember of a shale shaker's screen assembly mounting structure. Each opening 513 has, optionally, a bevelled edge 514 for ease of installation, e.g., but not limited to with fasteners, bolts, screws, pins, and/or around upstanding connectors on a shale shaker mounting structure. In certain aspects the openings 513 are located so that the wear strip 510 is slipped onto corresponding upstanding members of a shale shaker mounting structure (e.g. as in FIG. 33). The wear strip (and any wear strip herein) 510 may be made of any suitable material, e.g., but not limited to fiberglass, rubber, zinc, zinc alloy, urethane, BUNA-N, aluminum, aluminum alloy, steel, stainless steel, wood, iron or plastic as may be the upstanding member 512 (as may be any wear strip or mounting structure disclosed herein).

FIGS. 29A and 29B show a wear strip 520 according to the present invention which has a body 521 and an upstanding member 522 for receipt within a corresponding hole of a screen assembly. Using openings 523 at either end of the body 521, the wear strip 520 is connectible to an end or side or crossmember of a shale shaker's screen assembly mounting structure. Each opening 523 has, optionally, a bevelled edge 524 for ease of installation, e.g., but not limited to with fasteners, bolts, screws, pins, and/or around upstanding connectors on a shale shaker mounting structure. In certain aspects the openings 523 are located so that the wear strip 520 is slipped onto corresponding upstanding members of a shale shaker mounting structure (e.g. as in FIG. 33). The wear strip (and any wear strip herein) 520 may be made of any suitable material, e.g., but not limited to fiberglass, rubber, steel, stainless steel, wood, iron or plastic as may be the upstanding member 522.

FIGS. 30A and 30B show a wear strip 530 according to the present invention which has a body 531 and an upstanding member 532 for receipt within a corresponding hole of a screen assembly. Using openings 533 at either end of the body 531, the wear strip 530 is connectible to an end or side or crossmember of a shale shaker's screen assembly mounting structure. Each opening 533 has, optionally, a bevelled edge 534 for ease of installation, e.g., but not limited to with fasteners, bolts, screws, pins, and/or around upstanding connectors on a shale shaker mounting structure. In certain aspects the openings 533 are located so that the wear strip 530 is slipped onto corresponding upstanding members of a shale shaker mounting structure (e.g. as in FIG. 33). The wear strip (and any wear strip herein) 530 may be made of any suitable material, e.g., but not limited to fiberglass, rubber, steel, stainless steel, wood, iron or plastic as may be the upstanding member 532. As with any of the wear strips in FIGS. 28-32A, any desired number of upstanding members of any desired shape may be used. Also, any such upstanding member may be formed integrally of or connected to a wear strip according to the present invention.

FIGS. 31A and 31B show a wear strip 540 according to the present invention which has a body 541 and an upstanding member 542 for receipt within a corresponding hole of a screen assembly. Using openings 543 at either end of the body 541, the wear strip 540 is connectible to an end or side or crossmember of a shale shaker's screen assembly mounting structure. Each opening 543 has, optionally, a bevelled edge 544 for ease of installation, e.g., but not limited to with fasteners, bolts, screws, pins, and/or around upstanding connectors on a shale shaker mounting structure. In certain aspects the openings 543 are located so that the wear strip 540 is slipped onto corresponding upstanding members of a shale shaker mounting structure (e.g. as in FIG. 33). The wear strip (and any wear strip herein) 540 may be made of any suitable material, e.g., but not limited to fiberglass, rubber, steel, stainless steel, wood, iron or plastic as may be the upstanding member 542.

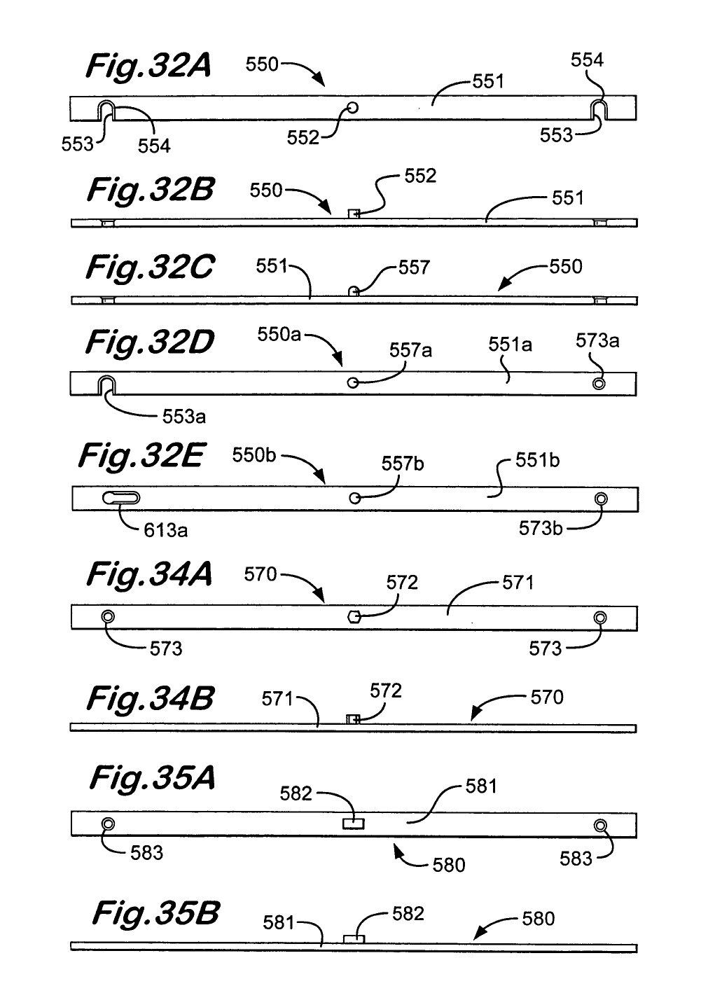

FIG. 32A-32C shows a wear strip 550 according to the present invention which has a body 551 and an upstanding member 552 (FIG. 32B) or 557 (FIG. 32C) for receipt within a corresponding hole of a screen assembly. Using openings 553 at either end of the body 551, the wear strip 550 is connectible to an end or side or crossmember of a shale shaker's screen assembly mounting structure. Each opening 553 has, optionally, a bevelled edge 554. Any upstanding member in any embodiment of the present invention may have a rounded surface as does the upstanding member 557. FIGS. 32D and 32E show wear strips with a hole at one end and an opening at the other end. FIG. 32D shows a wear strip 550a like the wear strip 550, FIG. 32A. The wear strip 550a has a body 551a, like the body 551 described above, with an opening 553a, like the opening 553 described above and with an upstanding member 557a, like the upstanding member 557 described above. The wear strip 550a also has a hole 573a, like the hole 573 described below. FIG. 32E shows a wear strip 550b like the wear strip 550, FIG. 32A. The wear strip 550b has a body 551b, like the body 551 described above, with an opening 613a, like the opening 613 described below and with an upstanding member 557b, like the upstanding member 557 described above. The wear strip 550b also has a hole 573b, like the hole 573 described below. The wear strips of FIGS. 32D and 32E are emplaceable on a tray with their end hole receiving an upstanding connector of the tray and with their other end opening encompassing another upstanding connector.

FIG. 33 discloses a tray 560 like the tray 400, FIG. 21 and like numerals indicate the same parts. Each end 402, 404 of the tray 560 has two spaced-apart upstanding connectors 562 useful for releasably attaching wear strips with appropriate openings (e.g., but not limited to, wear strips as in FIGS. 28-32C and 38A-41A, with appropriately sized openings) to the tray 560. Each connector 562 has a top 564 larger than a base 565 so that, e.g., upon sliding an opening (e.g., but not limited to an opening 513 of the wear strip 510, FIG. 28) around a connector 562, the top 564 abuts a top surface of the wear strip (which is made with an appropriate thickness) thereby holding the wear strip in position. One, three or more such connectors 562 may be used (with a corresponding opening or openings in a wear strip).

FIGS. 34A and 34B show a wear strip 570 according to the present invention with a body 571 and an upstanding member 572. Holes 573 at each end of the body 571 may be used for fasteners, bolts, screws, or pins to releasably secure the wear strip to a side of a shale shaker mounting structure which has corresponding holes for the fasteners, etc. Holes 573 (and any hole in FIGS. 35A-37A) may be bevelled as shown.

FIGS. 35A and 35B show a wear strip 580 according to the present invention with a body 581 and an upstanding member 582. Holes 583 at each end of the body 581 may be used for fasteners, bolts, screws, or pins to releasably secure the wear strip to a side of a shale shaker mounting structure which has corresponding holes for the fasteners, etc.

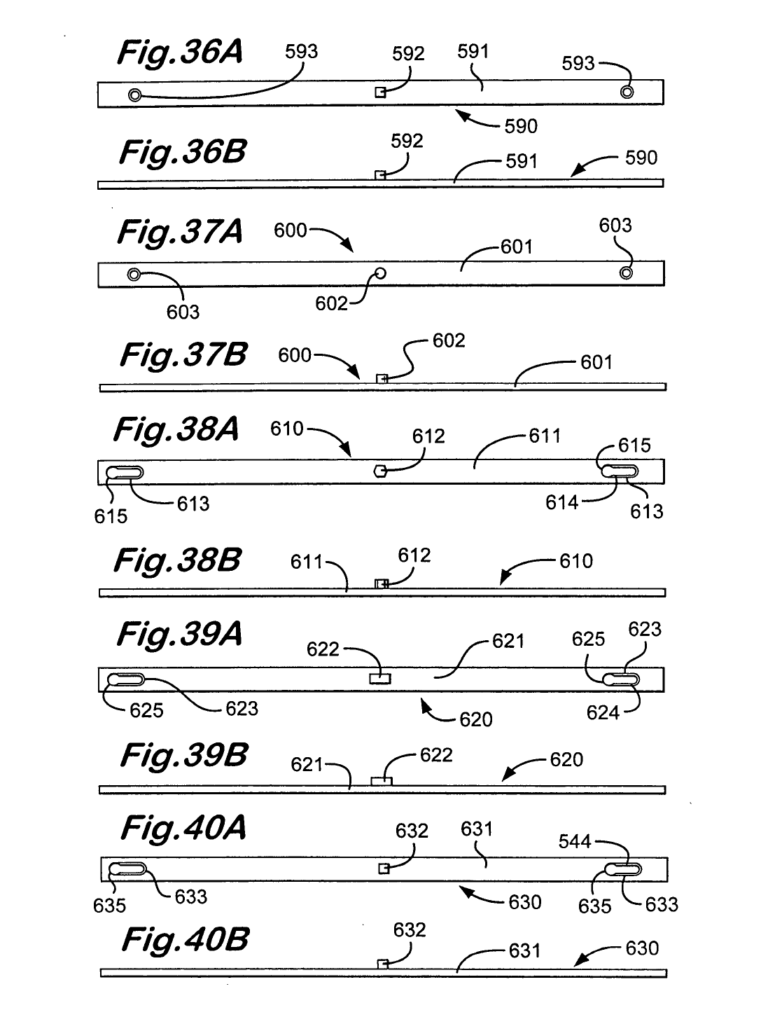

FIGS. 36A and 36B show a wear strip 590 according to the present invention with a body 591 and an upstanding member 592. Holes 593 at each end of the body 591 may be used for fasteners, bolts, screws, or pins to releasably secure the wear strip to a side of a shale shaker mounting structure which has corresponding holes for the fasteners, etc.

FIGS. 37A and 37B show a wear strip 600 according to the present invention with a body 601 and an upstanding member 602. Holes 603 at each end of the body 601 may be used for fasteners, bolts, screws, or pins to releasably secure the wear strip to a side of a shale shaker mounting structure which has corresponding holes for the fasteners, etc.

FIGS. 38A and 38B show a wear strip 610 according to the present invention which has a body 611 and an upstanding member 612 for receipt within a corresponding hole of a screen assembly. Using holes 613 at either end of the body 611, the wear strip 610 is connectible to an end or side or crossmember of a shale shaker's screen assembly mounting structure. Each opening 613 has, optionally, a bevelled edge portion 614 for ease of installation. A connector on a shaker tray can be inserted through a generally round part 615 of the openings 613 and then the wear strip is moved (to the left in FIG. 38A) to secure the wear strip in place with the connectors.

FIGS. 39A and 39B show a wear strip 620 according to the present invention which has a body 621 and an upstanding member 622 for receipt within a corresponding hole of a screen assembly. Using holes 623 at either end of the body 621, the wear strip 620 is connectible to an end or side or crossmember of a shale shaker's screen assembly mounting structure. Each opening 623 has, optionally, a bevelled edge portion 624 for ease of installation. A connector on a shaker tray can be inserted through a generally round part 625 of the openings 623 and then the wear strip is moved (to the left in FIG. 39A) to secure the wear strip in place with the connectors.

FIGS. 40A and 40B show a wear strip 630 according to the present invention which has a body 631 and an upstanding member 632 for receipt within a corresponding hole of a screen assembly. Using holes 633 at either end of the body 631, the wear strip 630 is connectible to an end or side or crossmember of a shale shaker's screen assembly mounting structure. Each opening 633 has, optionally, a bevelled edge portion 634 for ease of installation. A connector on a shaker tray can be inserted through a generally round part 635 of the openings 633 and then the wear strip is moved (to the left in FIG. 40A) to secure the wear strip in place with the connectors.

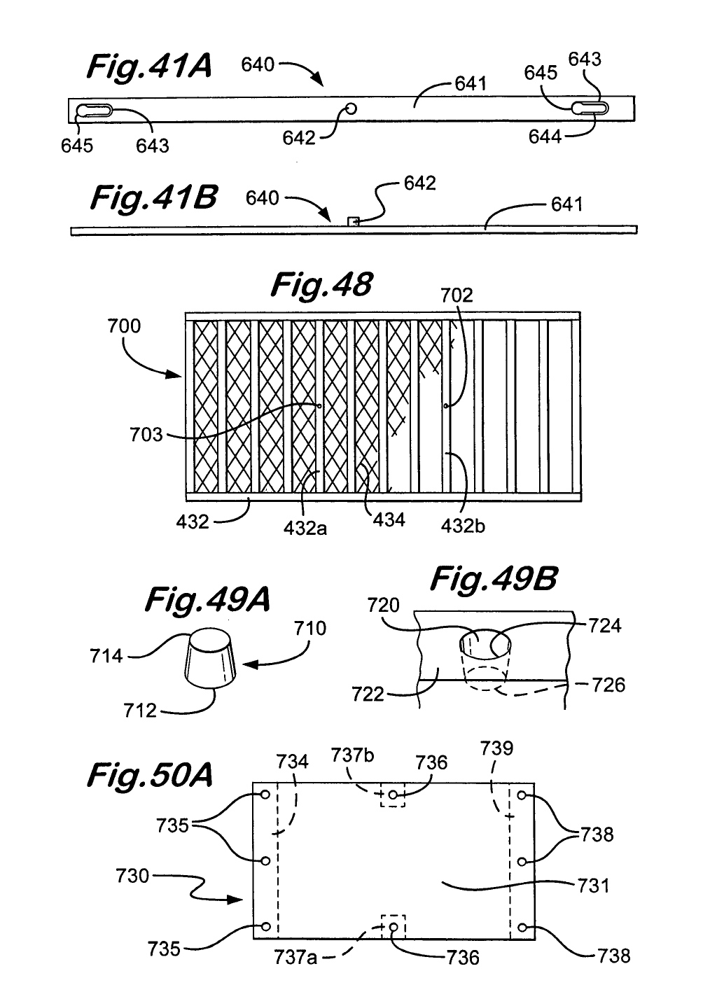

FIGS. 41A and 41B show a wear strip 640 according to the present invention which has a body 641 and an upstanding member 642 for receipt within a corresponding hole of a screen assembly. Using holes 643 at either end of the body 641, the wear strip 640 is connectible to an end or side or crossmember of a shale shaker's screen assembly mounting structure. Each opening 643 has, optionally, a bevelled edge portion 644 for ease of installation. A connector on a shaker tray can be inserted through a generally round part 645 of the openings 643 and then the wear strip is moved (to the left in FIG. 41A) to secure the wear strip in place with the connectors.

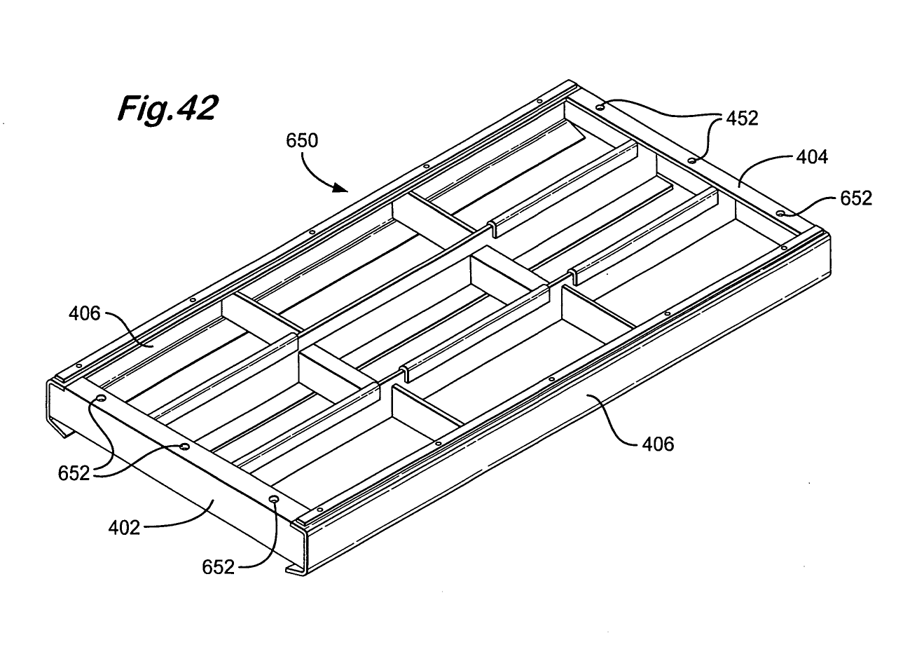

FIG. 42 shows a tray 650 according to the present invention for a screen assembly mounting structure of a shale shaker like the tray 400, FIG. 19, and like numerals indicate the same parts. The tray 650 has three holes 652 in each of its ends 402, 404. (Note that fluid flow over a screen assembly on the tray 650, and on any similar tray, may be from the top side 406 in FIG. 42 to the bottom side 406 in FIG. 42; or alternatively from end 402 to end 404). The holes 652 may be located, sized and configured for receipt therein of corresponding downwardly projecting members of a screen assembly or they may be used for releasably connecting a wear strip according to the present invention to the tray 65 (or they may be used for receiving fasteners that pass through a screen assembly, as may be any hole in any tray according to the present invention).

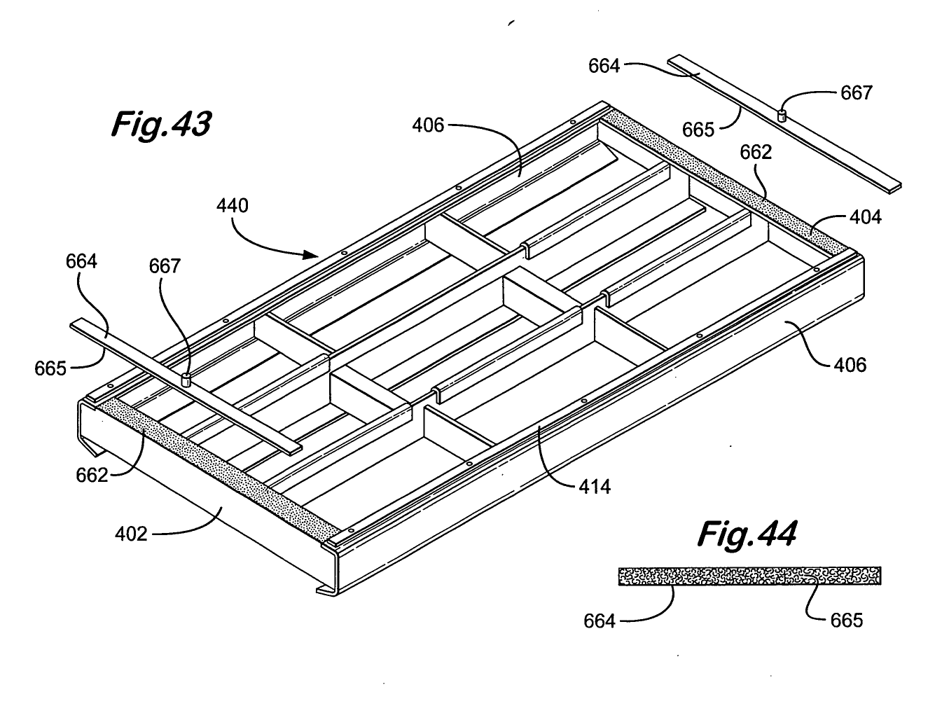

FIG. 43 shows a tray 660 according to the present invention like the tray 400 of FIG. 19 and like numerals indicate the same parts. Each end 402, 404 has on its top surface an amount 662 of releasably cooperating hook-and-loop connection material and each of two wear strips 664 has a corresponding amount 665 (see e.g. FIG. 44) of such releasably cooperating hook-and-loop connection material (e.g. but not limited to VELCRO™ material) for releasably connecting the wear strips 664 to the tops of the ends of tray 660. Each wear strip has an upstanding member 667 (like the upstanding member 420, FIG. 19). The wear strips 664 are shown above the tray 400 over the positions on the tray 664 at which they are connected in use (as is true for the wear strips shown above the tray in FIG. 45).

FIG. 45 shows a tray 670 according to the present invention like the tray 400 of FIG. 19 and like numerals indicate the same parts. Each end 402, 404 has on its top surface an amount 672 of two-sided adhesive tape for adhesively and releasably securing each of two wear strips 674 to the tops of the ends of tray 670. Each wear strip 674 has an upstanding member 677 (like the upstanding member 420, FIG. 19).

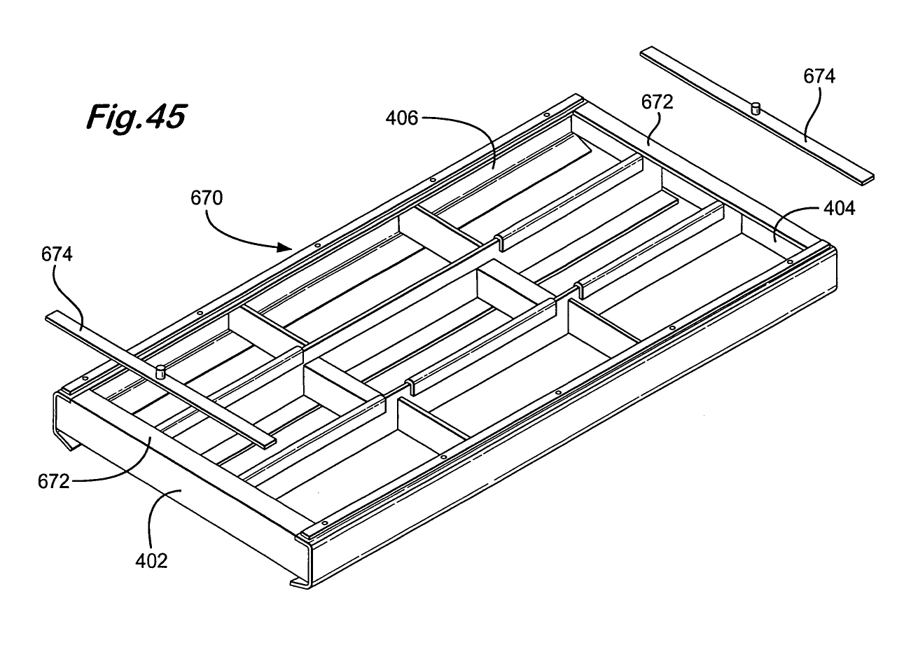

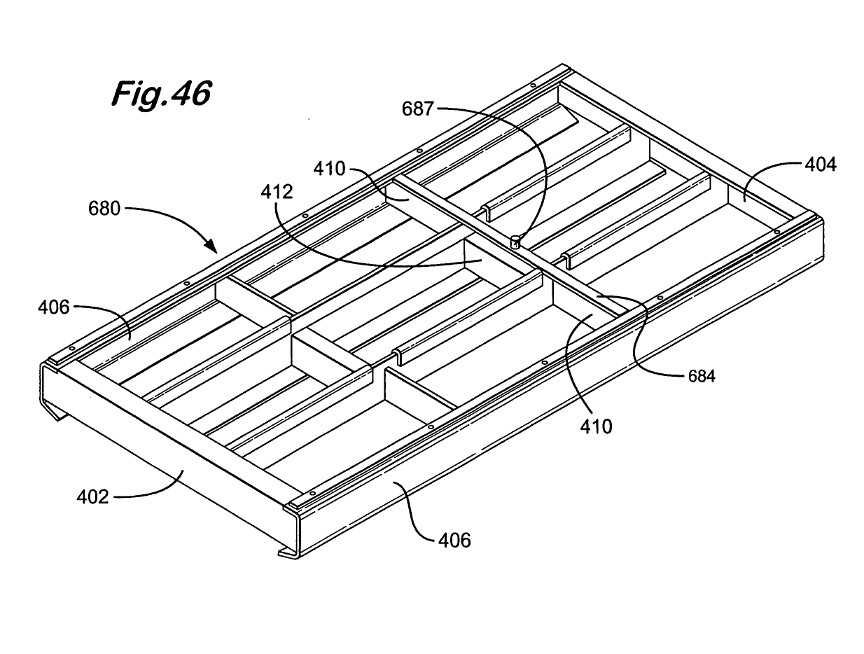

FIG. 46 shows a tray 680 according to the present invention like the tray 400, FIG. 19, and like numerals indicate the same parts. A wear strip 684 is secured on crossmembers 410, 412 as shown with any suitable securement, fastener, adhesive, and/or welding. It is within the scope of this invention to have a wear strip according to the present invention on any crossmember or crossmembers of a shale shaker's screen assembly mounting structure.

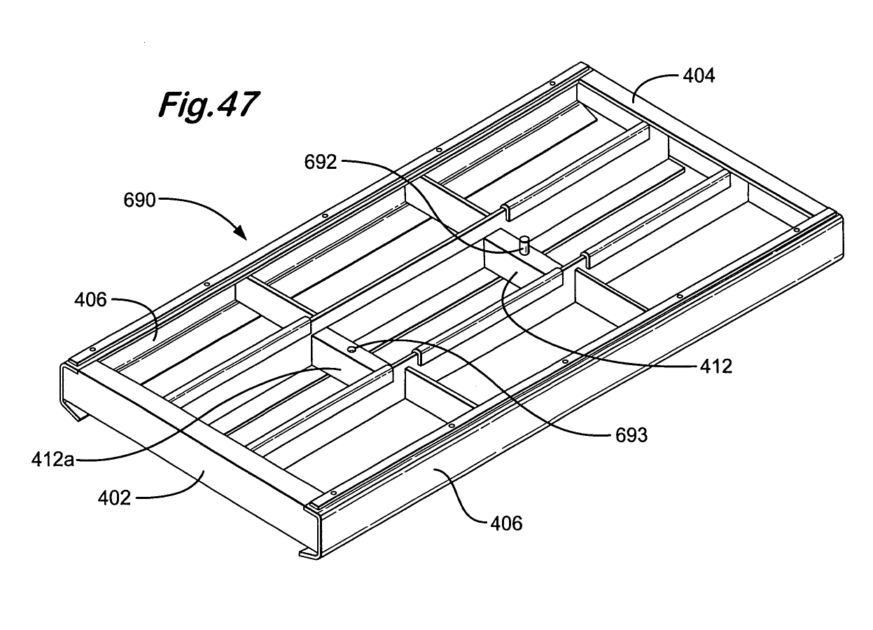

FIG. 47 shows a tray 690 according to the present invention like the tray 400, FIG. 19, and like numerals indicate the same parts. A crossmember 412 has an upstanding member 692 for receipt within a corresponding hole of a screen assembly emplaced on the tray 690. Another crossmember 412a has a hole 693 for receiving a downwardly projecting member of a screen assembly emplaced on the tray 690. Any number of holes 693 on any of the crossmembers may be used according to the present invention; and/or any number of upstanding members 692 may be used on any of the crossmembers. The hole 693 and upstanding member 692 may have any shape for holes and upstanding members, respectively, disclosed herein.

FIG. 48 shows a screen assembly 700 like the screen assembly 430, FIG. 20A, and like numerals indicate the same parts. One crossmember 432a of the frame 432 has a hole 703 sized, located and configured for receiving a corresponding upstanding member of a screen mounting structure of a shale shaker. A crossmember 432b of the frame 432 has a projecting member 702 for receipt within a corresponding hole in a screen mounting structure of a shale shaker. Any number of holes 703 may, according to the present invention, be used on a crossmember or crossmembers of the frame 432; and/or any number of projecting members 702 may, according to the present invention, be used on a crossmember or crossmembers of the frame 432.

FIG. 49A shows a projecting member 710 according to the present invention which may be used for any upstanding or upwardly projecting member or downwardly projecting member disclosed herein. The projecting member 710 has a base 712 larger than a top 714.

FIG. 49B shows a hole 720 in material 722 which has a top opening 724 larger than a hole bottom 726. Such a hole may be used for any hole in any embodiment of the present invention. The base 712 and top 714 (and the top opening 724 and hole bottom 726) may be any desired size, and the distance between them may be any desired length; and the shape of the top 714 and base 712 (and of the top openings 724 and hole bottom 726) may be any shape disclosed herein for an upstanding or upwardly projecting member.

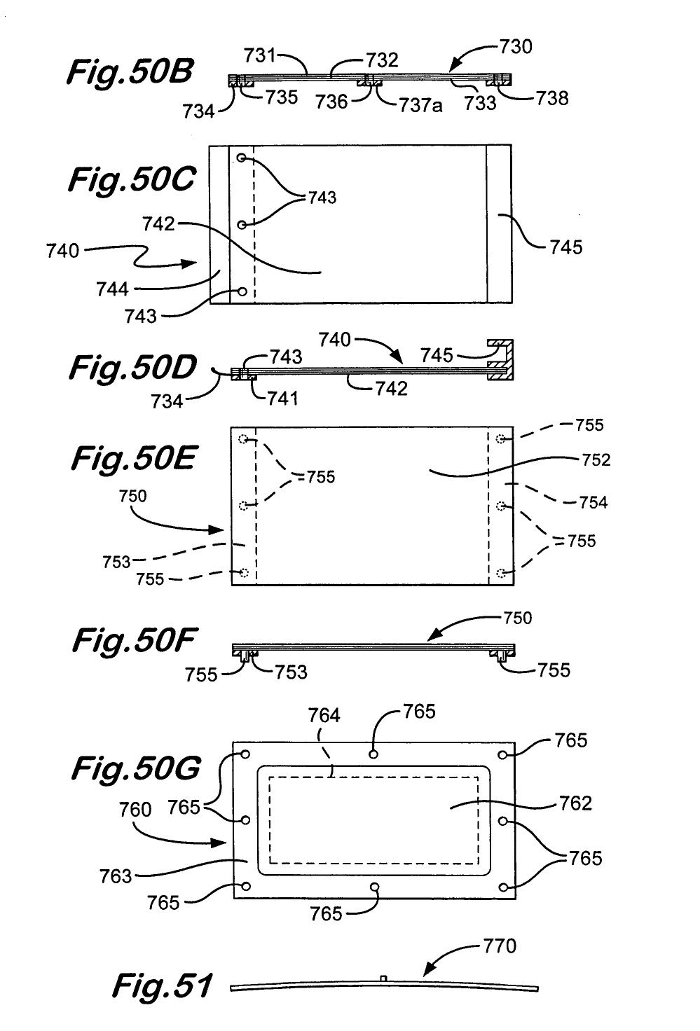

FIGS. 50A and 50B show a screen assembly 730 according to the present invention which has a plurality of glued-together layers of screening material 731, 732, 733 with a plate 734 attached at one end and secured to the lower layer 733 of screening material. Holes 735 extend through the screening material layers and through the plate 734. The plate 734 may be adhesively secured to the screening material and/or any suitable fastener and/or clamp apparatus may be used for such securement. The holes 735 may be used (as may the holes 743, FIG. 50C) as holes for receiving an upstanding member of a screen assembly mounting structure of a shale shaker; or fasteners may be inserted through the holes to releasably secure the screen assembly to a shale shaker screen assembly mounting structure. As with the glued-together layers of the screen assemblies of FIGS. 50C, 50E and 50G the screen assembly 730 may be any combination of two, three or more layers of screening material and/or mesh as disclosed or referred to in pending U.S. application Ser. Nos. 10/050,690 and 10/053,350 referred to above, said applications incorporated fully herein in their entirety for all purposes.

Optionally, the screen assembly 730 has holes 736 through the screening material and through plates 737a, 737b; and, optionally, holes 738 through a plate 739. It is within the scope of the present invention to provide a hole or holes on the outer periphery of the screen assembly 730 or to provide one or more holes with a corresponding lower plate (made of any suitable material including materials disclosed herein for wear strips and projecting members, rigid or flexible) at an inner area of the screen assembly 730 (and as may be provided in the screen assemblies of FIGS. 50C and 50E).

FIGS. 50C and 50D show a screen assembly 740 according to the present invention which has a plurality of glued-together layers of screening material 742 (like the layers 731-733, FIG. 50B) and holes 743 through a plate 741 (like the plate 734, FIG. 50B). Optionally, a flexible seal flap 744 is provided along an end (or side) of the screen assembly and it is within the scope of the present invention to provide such a flexible seal flap on the opposite side or end (or on any side or end of any known screen assembly) for sealing a screen-assembly-basket-wall interface when the screen assembly is in position in a shale shaker basket. A hook apparatus 745 is connected to one end (or side) of the screen assembly 740 and provides a hook structure that can be engaged by known screen mounting apparatuses. With pins or fasteners extending through the holes 743 to releasably connect the screen assembly 740 at one side of a screen basket, tension can be applied to the screen assembly 740 through the hook apparatus 745 for efficient tensioning and positioning of the screen assembly on a shale shaker.

FIGS. 50E and 50F show a screen assembly 750 according to the present invention which has a plurality of glued-together layers of screening material 752 with plates 753, 754 on either side of the screen assembly 750. Downwardly projecting members 755 (which may be like any downwardly projecting members disclosed herein) project down from the plates 753, 754 and are sized, located, and configured for receipt in corresponding holes of a screen assembly mounting structure of a shale shaker.

FIG. 50G shows a screen assembly 760 according to the present invention which has a plurality of glued-together layers of screening material 762 (like the layers 731-732, 742, and 752 disclosed above). An outer peripheral layer 763 of glue, adhesive, and/or epoxy surrounds the screen assembly 760 and a plurality of spaced-apart holes 765 extend through the layer 763 and through the layers of screening material. (Alternatively the layers 763 and/or 764 may be made of material like that of any plate in FIGS. 50A-50F.) Optionally a layer 764 like the layer 763 is provided on the bottom of the screen assembly 760. Any one, two, or three sides of either layer 763, 764 may be deleted, e.g. if holes are desired on less than all sides of the screen assembly. A plate or plates (rigid or flexible) may be positioned above layers of screening material above any plate in FIGS. 50A-50F.

FIG. 51 shows a wear strip 770 (which may be any wear strip according to the present invention) which is made in a bowed shape as shown in FIG. 51 so that it will exert an upward force on a screen assembly mounted above it in a shale shaker. Alternatively, any wear strip according to the present invention which is flexible may be connected to a shale shaker screen assembly mounting structure so that it is bowed upwardly. It is within the scope of the present invention to employ an initially-bowed wear strip in a flattened position so that in such flattened position it exerts an upward force on a screen assembly above it. This can be useful when wedges or other screen holding items are used which are made of a material such as rubber or urethane which can shrink or loose some of its resiliency in use thereby loosening the mounting of a screen assembly in a shale shaker.

The present invention, therefore, in some and not necessarily all embodiments, provides mounting structure for a shale shaker to which is releasably mountable a screen assembly, the mounting structure having a body over which a screen assembly is positionable, part of material to be treated by the shale shaker flowable through the body, at least one upwardly projecting member projecting upwardly from the body, the at least one upwardly projecting member sized and configured so it is receivable in a corresponding hole in the screen assembly.

The present invention, therefore, in some and not necessarily all embodiments, provides mounting structure for a shale shaker to which is releasably mountable a screen assembly, the mounting structure having a body over which a screen assembly is positionable, part of fluid to be treated by the shale shaker flowable through the body, at least one hole in the body projecting down into the body, the at least one hole sized and configured for receiving a corresponding downwardly projecting member of the screen assembly.

The present invention, therefore, in some and not necessarily all embodiments, provides a wear strip (any screen assembly mounting structure may have one, two, three, four or more of them—e.g., on two opposite ends, on two opposite sides, and/or on one or more crossmembers) for attachment to a mounting structure of a shale shaker to which is releasably mountable a screen assembly, the wear strip having a body, at least one upwardly projecting member projecting upwardly from the body member, the at least one upwardly projecting member sized, located and configured so it is receivable in a corresponding hole in the screen assembly.

The present invention, therefore, in some and not necessarily all embodiments, provides a screen assembly for releasable mounting to a mounting structure of a shale shaker, the screen assembly having one or more screen holes as described herein and/or one or more projecting members as described herein for mating with corresponding hole(s) and/or projecting member(s) of a screen mounting structure and/or a wear strip or wear strips thereof of a shale shaker.

The present invention, therefore, in some and not necessarily all embodiments, provides a shale shaker with: one, two, three or more screen assembly mounting structures as described herein; one, two, three, four or more wear strips as described herein; and/or one, two, three or more screen assemblies as described herein; and methods for their use.

The present invention, therefore, in some and not necessarily all embodiments, provides a screen assembly with a hole or holes in a surface of a support of a screen assembly, e.g., but not limited to in part of a tubular frame of a screen assembly, and a projecting member or members are moved into such hole or holes (e.g., a projecting member on a screen assembly holding member or structure or on an air bladder that is inflated above or below a screen assembly to secure it in place on a shaker deck, bed or tray). In certain such aspects the screen assemblies shown in the drawings and described herein have the hole or holes in the topmost surface of a screen frame or tubular support or in the bottom thereof.

It has been recognized that in some vibratory separators employing screening assemblies employing supports (or frames) made of relatively rigid material (e.g., hollow tubular mild steel with a square cross-section and a side measuring about ¾″ with a wall thickness of about ⅛″) that an effective seal between an edge or side of the support and part of a bed, basket or mounting structure of the vibratory separator is not achieved. In some aspects, two spaced-apart sides of a screen assembly are secured in place by edge mounting structure, wedge structures, or inflated bladders which push down on or wedge in the two spaced-apart sides. With a relatively rigid screen support, such mounting can result in insufficient flexing of the support so that sides of the support (not the sides contacted by the wedges or bladders) are not effectively sealed against the bed, etc., (or against a seal member on a bed, etc.) resulting in unsealed areas between the bed and the support through which pieces of drilled cuttings or other solids (which would normally move over and off the top of the screen assembly) can move, i.e., move through the open unsealed area (rather than as intended off the top of the screen for collection) and fall into a sump or reservoir (which is intended ideally to receive only filtered drilling fluid) from which they can be recycled back down into the wellbore negatively affecting drilling efficiency. One specific vibratory separator in which this problem may be encountered depending on the screen assemblies used is disclosed in U.S. Pat. No. 5,641,070 issued Jun. 24, 1997, incorporated fully herein for all purposes.

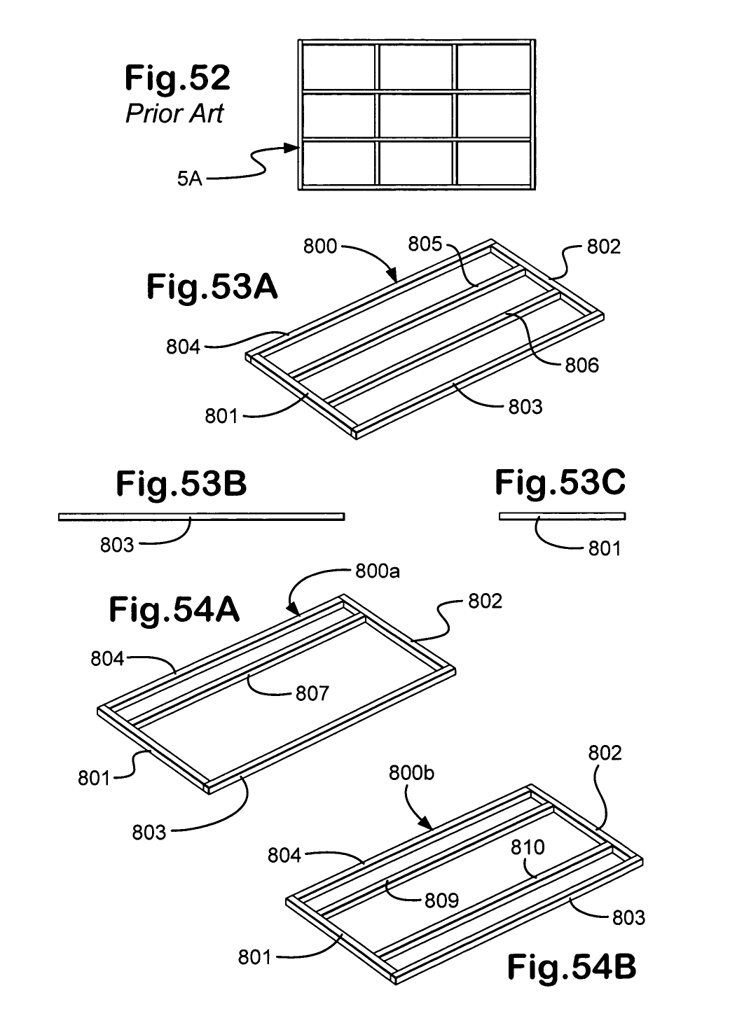

In one aspect this ineffective sealing problem is addressed according to the present invention by modifying a typical rigid prior art support for a screen assembly SA as shown in FIG. 52 by removing crossmembers shown in FIG. 52 that extend in one of two general directions between one or the other pair of two spaced-apart sides thereof, so that the remaining crossmembers are all positioned so that they lie generally in the direction of material flow on the screen assembly when it is in use on a vibratory separator or are all transverse to such flow direction; i.e., crossmembers are present in certain of the methods according to the present invention in only one direction, not both; and, in certain aspects, there are two, three, four, five, six or more of such crossmembers which, in one aspect, are equally spaced-apart across the screen assembly and from the sides thereof. Examples of such a support are shown in FIGS. 18A, 53A, and 62; and it is to be understood that the structure shown in these figures may be modified so that there are any desired number of crossmembers and, in one particular aspect, two or five such crossmembers equally spaced-apart across the support.

FIGS. 53A-53C show a support 800 according to the present invention for a screen assembly according to the present invention (which maybe, but is not limited to, any screen assembly according to the present invention disclosed or referred to herein and which may have on it any screening material referred to or disclosed herein). The support 800 has two spaced-apart sides 801, 802 and two spaced-apart sides 803, 804 (sides 801 and 802 identical; sides 803 and 804 identical). Extending from the side 801 to the side 802 are two crossmembers 805, 806. There are no crossmembers extending between the sides 803, 804. In one particular aspect all of the sides and crossmembers of the screen assembly are made from pieces of hollow mild steel with a square cross-section, a wall thickness of about one-eighth inch with a side about three-quarters of an inch long. In another aspect these pieces are solid (as may be the case with any support disclosed herein). The pieces are, in certain aspects, connected together by any known method, including but not limited to with fasteners, adhesives, and/or welding (e.g., “mig,” “tig,” or resistance welding) (as may be the case with any support and/or crossmember disclosed herein). In one particular aspect the screen assembly 800 is made of plastic, polymer and/or composite with or without strengthening metal rods and/or fibers therein (as may be the case with any support disclosed herein).

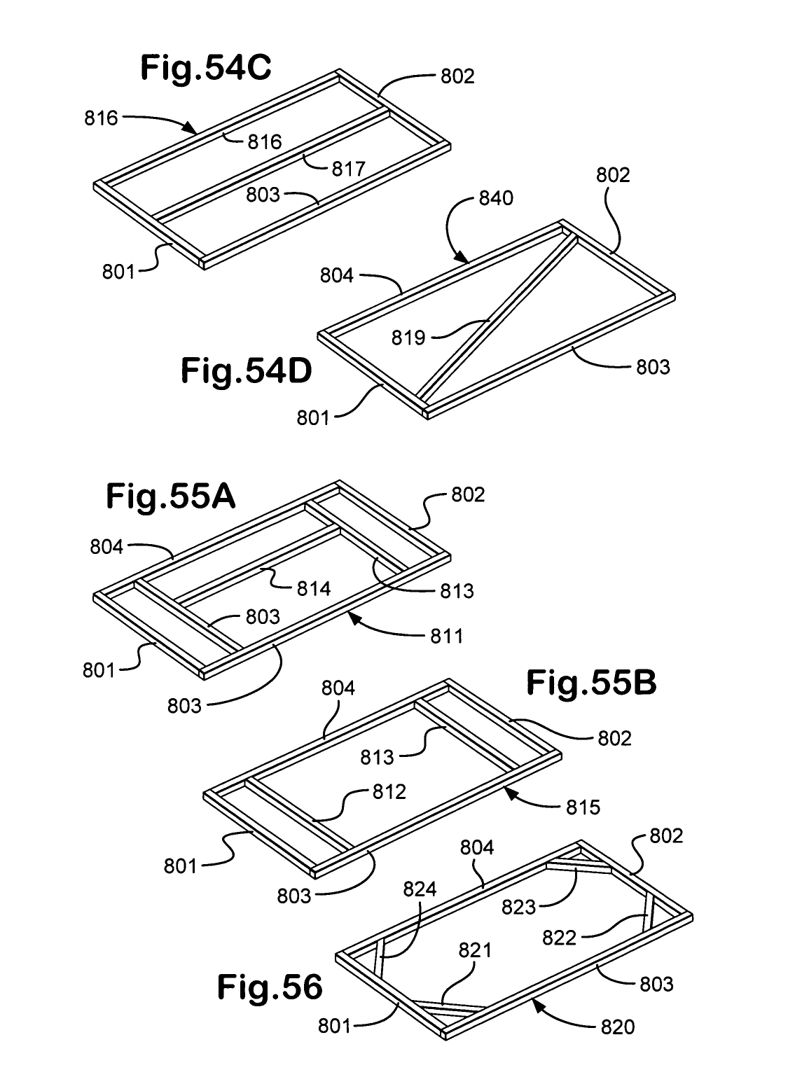

FIGS. 54A and 54B show alternative designs 800a and 800b of the screen assembly 800 of FIG. 52. In the screen assembly 800a like numerals indicate like parts; but instead of the crossmembers 805, 806, there is one crossmember 807 and it is closer to the side 804 than to the side 803 so that, in one aspect, in use the screen assembly may be positioned so that the side 803 is at a material exit end of a vibratory separator or at a material exit side of this particular screen assembly, while in another aspect this positioning is reversed and the side 804 is at the material exit end or side.

The screen assembly 800b, FIG. 54B, has no crossmembers 805, 806, but has two crossmembers 809, 810 each closer to a respective side 804, 803 than to a center of the screen assembly. FIG. 54C shows a screen assembly 816 (like the screen assembly 800 and like numerals indicate like parts) without crossmembers 805, 806; but with a single crossmembers 817 which may, according to the present invention, be located equidistant between the sides 803, 804.

The screen assembly 840, FIG. 54D, is like the screen assembly 800 (like numerals indicate like parts), but the crossmembers 805 and 806 are deleted and a crossmember 819 extends from the side 801 to the side 802 diagonally. It is also within the scope of the present invention for one end of the crossmember 819 to be connected to the side 803 or to the side 804, or for one end to be connected to the side 803 and one end connected to the side 804. It is also within the scope of the present invention to have two spaced-apart crossmembers 819 at the angle shown to the sides 101, 102 or at any desired angle, or they may crisscross across the support.

FIGS. 55A and 55B illustrate screen assemblies 811 and 815 which have sides 801-804 like the screen assembly 800, FIG. 53; but which have crossmembers 812, 813 between the sides 801, 802 (the crossmember 812, 813 like and connected to sides as the crossmembers 805, 806 except in length). The screen assembly 811 also has at least one crossmember 814 extending between and connected to the crossmembers 812, 813. It is within the scope of this invention for the crossmember 814 to be located as is any of the crossmembers 805, 806, 807, 809, or 810 with respect to the sides 803, 804.

FIG. 56 shows a screen assembly 820 with sides 801-804 (like in the screen assembly 800, FIG. 53); but with no crossmembers between either pair of sides. Instead, diagonal members 821-824 extend between and are each connected to two sides which are connected to each other (connected as any sides and crossmember are connected as disclosed herein). According to the present invention diagonal members 823, 824 or 821, 822 may be deleted; diagonal members 823, 821 or 824, 822 may be deleted; and the diagonal members may be any desired length. In certain aspects with respect to a screen assembly side (e.g. 803 or 804) which is to seal against screen mounting structure, the side having an entire length and a middle point, an end of the diagonal member (e.g. 823 or 824) is not within 10% of the length close to the middle point or, put another way, the end of the diagonal member is within 40% of the side to which its other end is connected; for example, in a screen assembly with such a side (e.g. 803 or 804) that is 50″ long, the diagonal member's end touching the 50″ long side is 10″ or more away from the middle of the 50″ long side. In one particular aspect a diagonal member (e.g. the diagonal member 824) is connected between the side 803 and the diagonal member 822 and/or the diagonal member 823 is connected between the diagonal member 821 and the side 803. Similarly, either or both diagonal members 821, 822 can be connected between a side and another diagonal member.

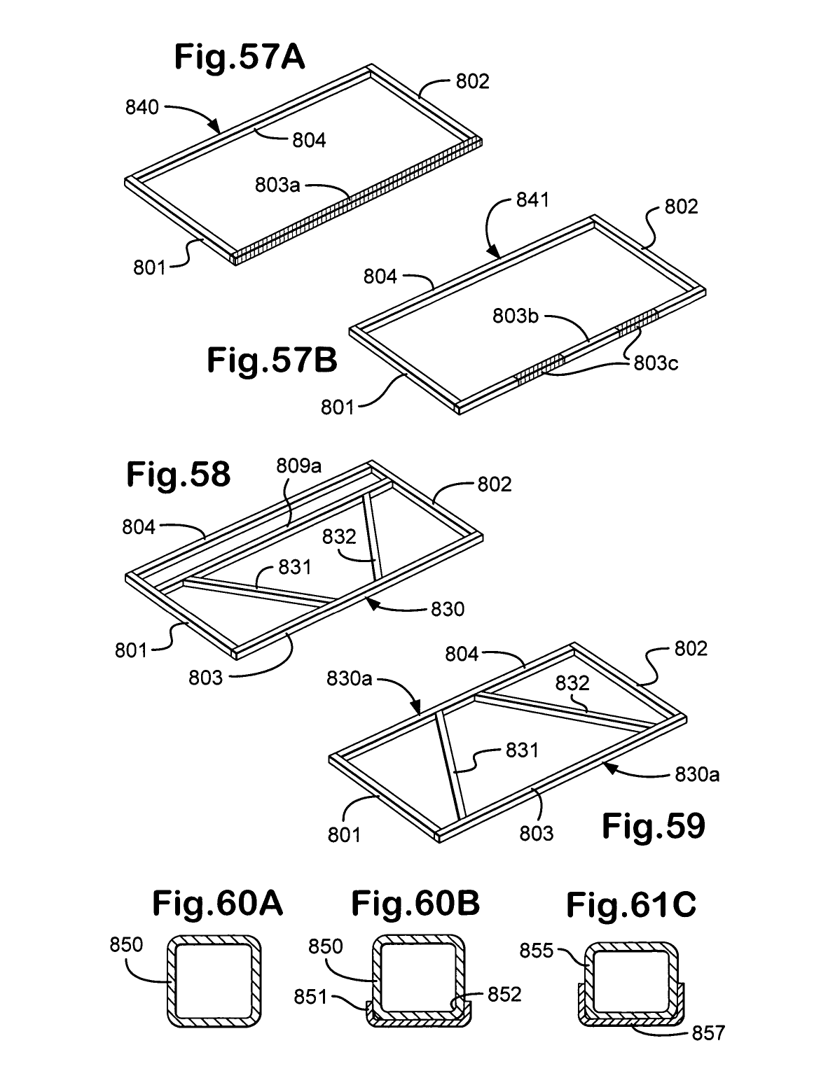

FIGS. 57A and 57B show, respectively, screen assemblies 840 and 841 according to the present invention which have sides 801, 802 and 804 as in the screen assembly 800, FIG. 83; but which have, instead of the side 803, a side 803a (FIG. 57A) or a side 803b (FIG. 57B). The side 803a is made of less rigid material than the side 803 and, in one aspect, of material less rigid than the other sides. In one particular aspect in which the sides 801, 802, and 804 are made of mild steel as described above, the side 803a is made of aluminum, fiberglass, plastic, polymer and/or composite with the same dimensions and shape but less rigid than the other sides, or, in one aspect, with the same outer measurements, but with a wall thickness sufficient to increase the side 803a's flexibility, and in particular aspect with a wall thickness of about one-tenth of an inch or less, and, in one aspect it may be made of aluminum with a wall thickness of about 0.080 inches. The side 803b has a portion 803c which is like the side 803a (in any of its possibilities) but which is only a portion of the side 803c, with end portions 803d like the side 803 (FIG. 53) or like the sides 801-802 in material, shape, and cross-section.

A side 803a or 803b may be used in any screen assembly support according to the present invention; or it may be used in any known prior art screen assembly; and, in one aspect one or two such sides may be used with a screen assembly as shown in FIG. 52 or any known screen assembly with one or more crossmembers to be positioned so that they are generally aligned parallel with or generally transverse to a general direction of material flow when the screen assembly is in use on a vibratory separator or shale shaker.

A screen assembly 830 according to the present invention shown in FIG. 58 is like the screen assemblies of FIGS. 54A, and 56 (like numerals indicate like parts); but the screen assembly 830 has two diagonal members 831, 832 that each have one end connected to the side 803 and one end connected to a crossmember 809a (like the crossmember 809, FIG. 54A). Alternatively the crossmember 809a is deleted and the diagonal members are connected to the sides 801 (diagonal member 831) and 802 (diagonal member 832); or the crossmember 809a is deleted and the diagonal members are connected between the side 803 and the side 804 with the diagonal members not parallel to the sides 801, 802 (one such embodiment, screen assembly 830a, shown in FIG. 59).

It is within the scope of the present invention for the diagonal members to be at any angle to the sides 103, 104 (however, in certain aspects they are not parallel to the sides 101, 102).

Any of the supports according to the present invention disclosed in FIGS. 53-59 may have any plate and/or backing cloth or coarse mesh connected thereto and any screening material disclosed or referred to herein, with the screening material on the plate, cloth, or mesh if one is present or, otherwise, directly on the support. Any support in FIGS. 53A-62 may have one or more holes for receiving fasteners according to the present invention as described above; and/or one or more holes for receiving a member projecting upwardly from the screen mounting structure as described above.

FIG. 60A shows in cross-section one embodiment for a hollow tubular member 850 which may be used for any side, end or crossmember of any embodiment described above. As shown in FIG. 60B, as desired a seal member 851 of any desired length may be releasably or permanently affixed to a lower part 852 of the seal member 850, e.g., with a push-on friction fit and/or with adhesive or glue. Such a seal member may be any desired thickness and may be used in discovered areas of actual ineffective sealing or applied to areas of anticipated ineffective sealing. In certain aspects a seal member like the seal member 850 may be provided in standard length and then cut to a desired length at a job site.

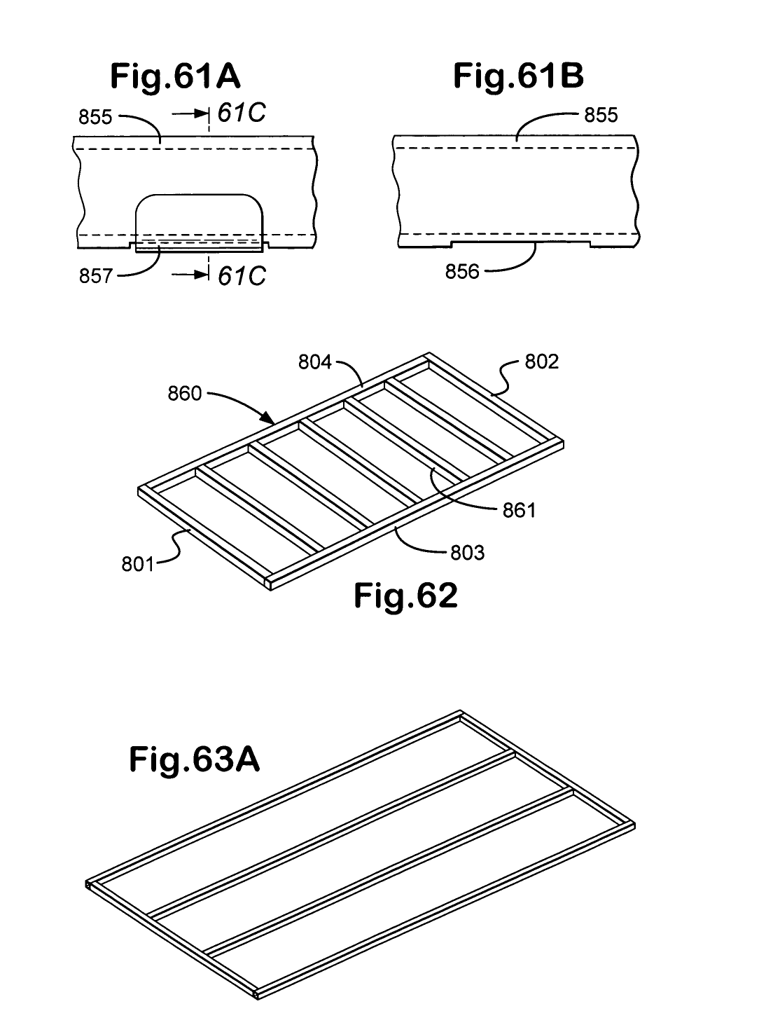

FIGS. 61A-61C show another embodiment of a hollow tubular member 855, like the tubular member 850, but with a recessed portion 856 for receiving part of a seal member 857 (like the seal member 851). One or more recessed portions 856 may be provided on any side or crossmember of any support described herein at anticipated locations of ineffective sealing or at discovered locations of ineffective sealing.

FIG. 62 shows a design for a screen assembly support 860 according to the present invention which is similar to the support 800, FIG. 53A, but without the crossmembers 805, 806 and with five spaced-apart crossmembers 861 (like the crossmembers 812, 813, FIG. 55A). End and side views of the support 860 are like those views of the support 800 (see FIGS. 53B and 53C).

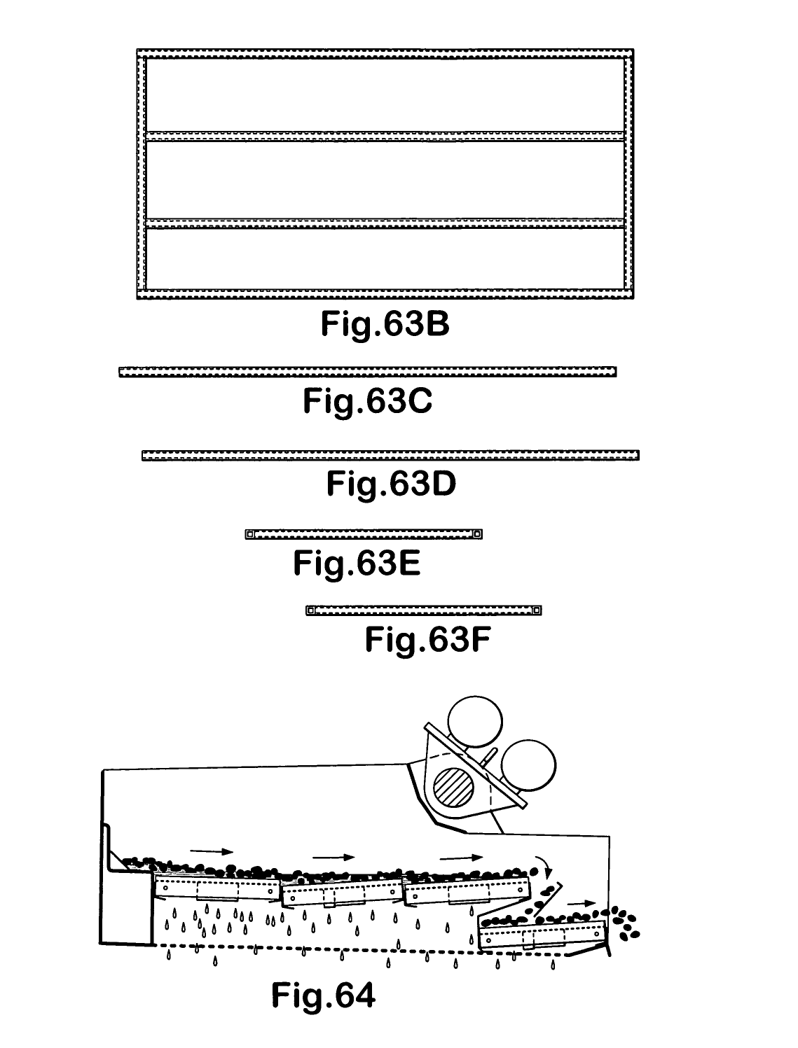

FIGS. 63A-63F show a design for a screen assembly support according to the present invention like the support 800, FIG. 53A. The ends and sides of the screen assembly shown in FIG. 62 are like those views of the screen assembly of FIG. 62—ends (FIGS. 63E, 63F) and the sides (FIGS. 63C, 63D).

FIG. 64 shows a Brandt King Cobra shale shaker 870 (commercially available from Brandt-Varco) with screen assemblies 871, 872, and 873 according to the present invention (which may be any screen assembly with any support according to the present invention with crossmembers located so that they are generally transverse to a direction of flow of material indicated by the arrows in FIG. 64, including, but not limited to the supports of FIGS. 53A and 63A). As shown by the arrows in FIG. 64, it is desirable that drilled solids 874, debris, etc. in drilling material 875 introduced to the shale shaker 870 for processing move on the tops of the screen assemblies 871, 872, 873 and that drilling fluid 877 filtered from the material 875 flow down into a sump 876. It is also desirable that as the solids, etc. move on top of the screens that, as viewed from above, the solids are uniformly and evenly distributed across the width of the screen assemblies. With a screen assembly with a prior art support as shown in FIG. 52 with crossmembers transverse to the length of the screen (crossmembers that in use would be generally parallel to the direction of material flow on the tops of the screen assemblies in FIG. 64), “dead zones” develop on top of the screen assemblies above the transverse crossmembers and solids do not move in these dead zones or do not move as readily in these dead zones, creating a relatively larger mass of solids that moves along areas of the tops of the screen assemblies not above these crossmembers resulting in a non-uniform flow of solids on the tops of the screens. Such undesirable masses of solids may not have as much fluid removed from them if the dead zones were not present. By removing these crossmembers and using a support, e.g. as in FIGS. 53A and 63A, the occurrence and/or size of these dead zones is reduced and greater processing efficiency is achieved. The relatively large masses of material moving on the top of a screen assembly with the prior art support can increase wear of the screen mesh and contribute to a shorter useful screen assembly life. If a screen assembly with the prior art support has these undesirable relatively large masses of solids moving on top of it, and the screen assembly is ineffectively sealed to the shaker's basket, deck, or bed for supporting screen assemblies, the problem with solids moving through an unsealed area into the sump is exacerbated.

The present invention, therefore, provides in some, but not necessarily all, embodiments a method for mounting a screen assembly to a screen mounting structure of a vibratory separator to facilitate sealing of an interface between the the screen assembly and the screen mounting structure, the screen mounting structure including a plurality of support members extending from a first separator side of the vibratory separator to a second separator side thereof with material flowable between said sides in a first direction that is a direction generally parallel to said sides, the screen assembly having a support and screening material on the support for treating material introduced to the vibratory separator, the support including four interconnected sides including two pairs of sides, a first pair with a first side and a second side and a second pair with a third side and a fourth side, the first side spaced-apart from the second side by spaced-apart third and fourth sides, the first side and the second side generally parallel to the first separator side and the second separator side upon installation of the screen assembly in the vibratory separator, the support having generally flat or three-dimensional screening material thereon, the support having a plurality of spaced-apart crossmembers extending between and connected to only one of the pairs of sides, each crossmember not in contact with and independent of all other crossmembers, the screen mounting structure including crowning apparatus for forcible abutment against the third side and the fourth side of the support to effect bending of the first side and the second side of the support and thereby effect crowning of the screen assembly within the vibratory separator, the method in certain aspects including locating the screen assembly on the screen mounting structure, positioning the screen assembly with respect to the screen mounting structure so that the crossmembers are all either generally transverse to or all generally parallel to the first direction, and forcing the first and second sides of the support down with the crowning apparatus to effect crowning of the screen assembly, the third and fourth sides rigid yet sufficiently flexible so that with the screen assembly in a crowned configuration the third side and the fourth side each along substantially all of the length thereof sealingly contact a surface of the screen mounting structure. Such a method may include one or some, in any possible combination, of the following: wherein the plurality of spaced-apart crossmembers is two crossmembers generally parallel to the third side and the fourth side; wherein the plurality of spaced-apart crossmembers is five crossmembers generally parallel to the first direction; wherein the first side and the second side are each made of material less rigid than material of the third side and the fourth side; wherein the first side has at least a portion thereof made of material less rigid than material of the third side and the fourth side; connecting a seal member at a first location of an exterior of at least one of the first side or the second side to remedy ineffective sealing at said first location; wherein the seal member has at least a portion thereof within a recess at the first location; wherein the screen mounting structure has a body with at least one upwardly projecting member projecting upwardly from the body member, said at least one upwardly projecting member sized and configured so it is receivable in a corresponding hole in the support, the method further including positioning the screen assembly on the screen mounting structure so that the at least one upwardly projecting member is received in the corresponding hole of the support; wherein the at least one upwardly projecting member is a plurality of spaced-apart upwardly projecting members and wherein the at least one hole in the support is a plurality of spaced-apart holes, each for receiving a corresponding upwardly projecting member; wherein the corresponding hole in the support is in a crossmember of the support; wherein the vibratory separator is a shale shaker for separating components of drilling material introduced thereto, the drilling material including drilling fluid and drilled cuttings, the shale shaker having a basket, the screen mounting structure on the basket, the support having a plurality of spaced apart support holes therethrough, each hole of the plurality of spaced apart support holes for receiving part of a fastener used for releasably connecting the screen assembly to the screen mounting structure, the screen mounting structure having a plurality of spaced-apart deck holes corresponding to the plurality of spaced-apart support holes through the support, and fasteners connecting the screen assembly to the screen mounting structure, each fastener passing through the screening material, through a support hole, and into a deck hole, the method further including connecting the support to the screen mounting structure with the fasteners; wherein the fasteners are from the group including or consisting of threaded fasteners, screens, bolts, locking fasteners, finger expansion fasteners, air injection fasteners, and friction-fit fasteners; wherein the fasteners are adhesively secured in place; wherein the screening material is a plurality of layers of screen mesh; wherein the screen assembly has on the support a perforated plate; wherein the sides of the support are hollow tubular members; wherein all of the crossmembers are generally transverse to the first direction, the material introduced to the vibratory separator containing solids not passable through the screening material, the solids movable on a top of the screening assembly by the vibratory separator, the method further including moving the solids uniformly on the top of the screening assembly; wherein the material is drilling material and the solids include drilled solids; and/or wherein the solids are moved on the top of the screen assembly without the formation of significant dead zones on the top of the screen assembly.

The present invention also provides designs according to the present invention for a support for a screen assembly.

In conclusion, therefore, it is seen that the present invention and the embodiments disclosed herein and those covered by the appended claims are well adapted to carry out the objectives and obtain the ends set forth. Certain changes can be made in the subject matter without departing from the spirit and the scope of this invention. It is realized that changes are possible within the scope of this invention and it is further intended that each element or step recited in any of the following claims is to be understood as referring to all equivalent elements or steps. The following claims are intended to cover the invention as broadly as legally possible in whatever form it may be utilized. The invention claimed herein is new and novel in accordance with 35 U.S.C. § 102 and satisfies the conditions for patentability in § 102. The invention claimed herein is not obvious in accordance with 35 U.S.C. § 103 and satisfies the conditions for patentability in § 103. This specification and the claims that follow are in accordance with all of the requirements of 35 U.S.C. § 112.

1. A method for mounting a screen assembly to a screen mounting structure of a vibratory separator to facilitate sealing of an interface between the the screen assembly and the screen mounting structure, the screen mounting structure including a plurality of support members extending from a first separator side of the vibratory separator to a second separator side thereof with material flowable between said sides in a first direction that is a direction generally parallel to said sides, the screen assembly having a support and screening material on the support for treating material introduced to the vibratory separator, the support including four interconnected sides including two pairs of sides, a first pair with a first side and a second side and a second pair with a third side and a fourth side, the first side spaced-apart from the second side by spaced-apart third and fourth sides, the first side and the second side generally parallel to the first separator side and the second separator side upon installation of the screen assembly in the vibratory separator, the support having generally screening material thereon, the support having a plurality of spaced-apart crossmembers extending between and connected to only one of the pairs of sides, each crossmember not in contact with and independent of all other crossmembers, the screen mounting structure including crowning apparatus for forcible abutment against the third side and the fourth side of the support to effect bending of the first side and the second side of the support and thereby effect crowning of the screen assembly within the vibratory separator, the method comprising
locating the screen assembly on the screen mounting structure,
positioning the screen assembly with respect to the screen mounting structure so that the crossmembers are all either generally transverse to or all generally parallel to the first direction, and
forcing the first and second sides of the support down with the crowning apparatus to effect crowning of the screen assembly, the support rigid yet sufficiently flexible so that with the screen assembly in a crowned configuration the third side and the fourth side each along substantially all of the length thereof sealingly contact a surface of the screen mounting structure.

2. The method of claim 1 wherein the plurality of spaced-apart crossmembers is two crossmembers generally parallel to the third side and the fourth side.

3. The method of claim 1 wherein the plurality of spaced-apart crossmembers is five crossmembers generally parallel to the first direction.

4. The method of claim 1 wherein the first side and the second side are each made of material less rigid than material of the third side and the fourth side.

5. The method of claim 1 wherein the first side has at least a portion thereof made of material less rigid than material of the third side and the fourth side.

6. The method of claim 1 further comprising
connecting a seal member at a first location of an exterior of at least one of the first side or the second side to remedy ineffective sealing at said first location.

7. The method of claim 6 wherein the seal member has at least a portion thereof within a recess at the first location.

8. The method of claim 1 wherein the screen mounting structure has a body with at least one upwardly projecting member projecting upwardly from the body member, said at least one upwardly projecting member sized and configured so it is receivable in a corresponding hole in the support, the method further comprising
positioning the screen assembly on the screen mounting structure so that the at least one upwardly projecting member is received in the corresponding hole of the support.

9. The method of claim 8 wherein the at least one upwardly projecting member is a plurality of spaced-apart upwardly projecting members and wherein the at least one hole in the support is a plurality of spaced-apart holes, each for receiving a corresponding upwardly projecting member.

10. The method of claim 8 wherein the corresponding hole in the support is in a crossmember of the support.

11. The method of claim 1 wherein the vibratory separator is a shale shaker for separating components of drilling material introduced thereto, the drilling material including drilling fluid and drilled cuttings, the shale shaker having a basket, the screen mounting structure on the basket, the support having a plurality of spaced apart support holes therethrough, each hole of the plurality of spaced apart support holes for receiving part of a fastener used for releasably connecting the screen assembly to the screen mounting structure, the screen mounting structure having a plurality of spaced-apart deck holes corresponding to the plurality of spaced-apart support holes through the support, and fasteners connecting the screen assembly to the screen mounting structure, each fastener passing through the screening material, through a support hole, and into a deck hole, the method further comprising
connecting the support to the screen mounting structure with the fasteners.

12. The method of claim 11 wherein the fasteners are from the group consisting of threaded fasteners, screens, bolts, locking fasteners, finger expansion fasteners, air injection fasteners, and friction-fit fasteners.

13. The method of claim 11 wherein the fasteners are adhesively secured in piece.

14. The method of claim 11 wherein the screening material comprises a plurality of layers of screen mesh.

15. The method of claim 11 wherein the screen assembly has on the support a perforated plate.

16. The method of claim 11 wherein the sides of the support comprise hollow tubular members.

17. The method of claim 1 wherein all of the crossmembers are generally transverse to the first direction, the material introduced to the vibratory separator containing solids not passable through the screening material, the solids movable on a top of the screening assembly by the vibratory separator, the method further comprising
moving the solids uniformly on the top of the screening assembly.

18. The method of claim 17 wherein the material is drilling material and the solids include drilled solids.

19. The method of claim 17 wherein the solids are moved on the top of the screen assembly without the formation of significant dead zones on the top of the screen assembly.

20. (cancelled).

21. A screen assembly for releasable mounting to a mounting structure of a shale shaker, the mounting structure comprising a body over which a screen assembly is positionable, part of fluid to be treated by the shale shaker flowable through the body, at least one upwardly projecting member projecting upwardly from the body, said at least one upwardly projecting member sized and configured so it is receivable in a corresponding hole in the screen assembly, said at least one projecting member having a projecting member cross-sectional area, the screen assembly comprising k
a support,
screening material on the support,
the support comprising a frame with two spaced-apart ends, the two spaced-apart ends spaced-apart by two spaced-apart sides, each of the two spaced-apart sides connected to each of the two spaced-apart ends, the frame having a plurality of spaced-apart crossmembers extending between the two spaced-apart sides from one side to the other side, at least part of the frame comprising a tubular member with a top and a bottom, a portion of the screening material on top of the tubular member,
at least one hole in the bottom of the tubular member, said at least one hole sized, configured, and located for receiving said at least one upwardly projecting member of the body of the mounting structure, sold at least one hole having a hole cross-sectional area greater than said projecting member cross-sectional area.

22. A shale shaker system for separating components of drilling fluid with solids entrained therein, the shale shaker system comprising
a base,
a screen mounting basket on the base,
vibrating apparatus connected to the screen mounting basket for vibrating the screen mounting basket,
the screen mounting basket comprising mounting structure for at least one screen assembly mounted on the mounting structure, the mounting structure comprising a body over which the at least one screen assembly is positionable, part of the drilling fluid to be treated by the shale shaker flowable through the at least one screen assembly and through the body,
at least one screen assembly mounted on the mounting structure,
the at least one screen assembly comprising a screen assembly for releasable mounting to the mounting structure of a shale shaker,
the mounting structure having at least one upwardly projecting member projecting upwardly from the body, said at least one upwardly projecting member sized and configured so it is receivable in a corresponding hole in the screen assembly, said at least one projecting member having a projecting member cross-sectional area,
the at least one screen assembly including
a support,
screening material on the support,
the support comprising a frame with two spaced-apart ends, the two spaced-apart ends spaced-apart by two spaced-apart sides, each of the two spaced-apart sides connected to each of the two spaced-apart ends, the frame having a plurality of spaced-apart crossmembers extending between the two spaced-apart sides from one side to the other side, at least part of the frame comprising a tubular member with a top and a bottom, a portion of the screening material on top of the tubular member, and
at least one hole in the bottom of the tubular member, said at least one hole sized, configured, and located for receiving said at least one upwardly projecting member of the body of the mounting structure, said at least one hole having a hole cross-sectional area greater than said projecting member cross-sectional area.

23. A screen assembly for releasable mounting to a mounting structure of a shale shaker, the mounting structure comprising a body over which a screen assembly is positionable, part of fluid to be treated by the shale shaker flowable through the body, at least one upwardly projecting member projecting upwardly from the body, said at least one upwardly projecting member sized and configured so it is receivable in a corresponding hole in the screen assembly, said at least one projecting member having a projecting member cross-sectional area, the screen assembly comprising
a support,
screening material on the support,
the support comprising a frame with two spaced-apart ends, the two spaced-apart ends spaced-apart by two spaced-apart sides, each of the two spaced-apart sides connected to each of the two spaced-apart ends, the frame having a plurality of spaced-apart crossmembers extending between the two spaced-apart sides from one side to the other side, at least part of the frame comprising a tubular member with a top and a bottom, a portion of the screening material on top of the tubular member,
at least one hole in the tubular member, said at least one hole sized, configured, and located for receiving said at least one upwardly projecting member of the body of the mounting structure, said at least one hole having a hole cross-sectional area greater than said projecting member cross-sectional area.

24. A shale shaker system for separating components of drilling fluid with solids entrained therein, the shale shaker system comprising
a base,
a screen mounting basket on the base,
vibrating apparatus connected to the screen mounting basket for vibrating the screen mounting basket,
the screen mounting basket comprising mounting structure for at least one screen assembly mounted on the mounting structure, the mounting structure comprising a body over which the at least one screen assembly is positionable, part of the drilling fluid to be treated by the shale shaker flowable through the at least one screen assembly and through the body,
at least one screen assembly mounted on the mounting structure,
the at least one screen assembly comprising a screen assembly for releasable mounting to the mounting structure of a shale shaker,
the mounting structure having at least one upwardly projecting member projecting upwardly from the body, said at least one upwardly projecting member sized and configured so it is receivable in a corresponding hole in the screen assembly, said at least one projecting member having a projecting member cross-sectional area,
the at least one screen assembly including
a support,
screening material on the support,
the support comprising a frame with two spaced-apart ends, the two spaced-apart ends spaced-apart by two spaced-apart sides, each of the two spaced-apart sides connected to each of the two spaced-apart ends, the frame having a plurality of spaced-apart crossmembers extending between the two spaced-apart sides from one side to the other side, at least part of the frame comprising a tubular member with a top and a bottom, a portion of the screening material on top of the tubular member, and
at least one hole in the tubular member, said at least one hole sized, configured, and located for receiving said at least one upwardly projecting member of the body of the mounting structure, said at least one hole having a hole cross-sectional area greater than said projecting member cross-sectional area.
